(19) United States
(12) Patent Application Publication
(10) Pub. No.: US 2024/0333550 A1
(43) Pub. Date: Oct. 3, 2024

(54) ELECTRONIC DEVICE CONTROLLER, COMMUNICATION TERMINAL, AND ELECTRONIC DEVICE

(71) Applicant: TESNOLOGY Inc., Tokyo (JP)

(72) Inventor: Katsuhiko KONDO, Minato-ku, Tokyo (JP)

(21) Appl. No.: 18/578,078

(22) PCT Filed: May 25, 2022
(86) PCT No.: PCT/JP2022/021336

§ 371 Date: Jan. 10, 2024

(30) Foreign Application Priority Data
Jul. 12, 2021 (JP) 2021-114857

(51) Int. Cl. H04L 12/28

(52) U.S. Cl. CPC H04L 12/282; H04L 12/2807

(57) ABSTRACT

An integrated terminal includes: a use history managing unit to manage use history of an electronic device for each user; a turn-on receiving unit to receive a turn-on signal to turn on the electronic device together with a user ID from a user terminal; a turn-on transmitting unit to transmit a turn-on signal to the electronic device upon receiving the turn-on signal; and a setting transmitting unit to transmit a setting signal based on the use history associated with the user ID to the electronic device.

### TECHNICAL FIELD

The present invention relates to a technology for controlling one or more electronic devices.

### BACKGROUND ART

Many home appliances come with a remote control. As the number of home appliances increases, the number of remote controls also increases and management of remote controls becomes troublesome. It will be convenient if multiple home appliances can be controlled by a single remote control (refer to Patent Literatures 1 and 2).

### RELATED ART LIST

### Patent Literatures

Patent Literature 1: JP 4543792 B2
Patent Literature 2: JP 2020-141235 A

### SUMMARY

### Technical Problem

Patent Literature 1 teaches a technology for integrating the functions of a plurality of remote controls into one device. In Patent Literature 1, however, simultaneous control of a plurality of peripherals (home appliances) by a single operation is not considered.

In contrast, a controller taught in Patent Literature 2 can simultaneously control a plurality of devices by a single operation. For example, it is taught that, when a voice command “good morning” is input, air conditioning equipment, lighting equipment, and an electric shutter located in a living room can be driven together. Furthermore, the controller changes its method of controlling devices by using additional information such as a “period”. For example, the air conditioning equipment is set to “cooling” in summer and to “heating” in winter (refer to paragraph [0081] of Patent Literature 2). In the case of the controller of Patent Literature 2, however, it is necessary to associate a device to be controlled by each command in advance and to set a method for controlling a device properly depending on additional information in advance, and the work for these associations and settings are troublesome.

Furthermore, recent home appliances have been sophisticated, which enables setting of detailed and various operating conditions. As the settings become more complicated, less users can make full use of actual high functionality of home appliances.

The present invention has been achieved on the basis of recognition of the aforementioned problems, and a chief object thereof is to provide a technology for appropriately controlling electronic devices such as home appliances according to users' lifestyles.

### Solution to Problem

An electronic device controller according to an aspect of the present invention includes: a basic setting storage unit storing basic setting information associating a user ID and a time period with operating conditions of one or more electronic devices; a user identifying unit to obtain a user ID by identifying a user; and a device control unit to control one or more electronic devices on the basis of the identified user and a current time by referring to the basic setting information.

When the user has instructed to change an operating condition of an electronic device, the device control unit changes the operating condition of the electronic device and updates the basic setting information.

An electronic device according to an aspect of the present invention includes: a receiving unit to receive a control signal including a command ID, a device ID, and an operation command via near field radio communication from an external electronic device controller; an operation control unit to perform operation settings of the electronic device in accordance with the operation command included in the control signal when the received device ID is a device ID of the electronic device; and a transmitting unit to transmit the control signal via near field radio communication.

The transmitting unit refers to the command ID in the received control signal and, when the control signal has not been previously received, transmits the control signal.

An electronic device controller according to an aspect of the present invention includes: a use history managing unit to manage use history of an electronic device for each user; a turn-on receiving unit to receive a turn-on signal to turn on the electronic device together with a user ID from a user terminal; a turn-on transmitting unit to transmit a turn-on signal to the electronic device upon receiving the turn-on signal; and a setting transmitting unit to transmit a setting signal based on the use history associated with the user ID to the electronic device.

A communication terminal according to an aspect of the present invention includes: an operation screen display unit to display an operation screen including turn-on buttons respectively associated with a plurality of electronic devices; an acknowledgement signal receiving unit to receive an acknowledgement signal from an electronic device controller; a specifying information transmitting unit to transmit specifying information of an electronic device to the electronic device controller after the acknowledgement signal is received; an operation screen generating unit to add a turn-on button for the electronic device on the operation screen after the specifying information is transmitted; and a turn-on signal transmitting unit to transmit a turn-on signal for an electronic device associated with a selected turn-on button to the electronic device controller when one of the turn-on buttons displayed on the operation screen is selected.

An electronic device according to an aspect of the present invention includes: a use history managing unit to manage use history of the electronic device for each user; a turn-on receiving unit to receive a turn-on signal together with a user ID from a user terminal; a turn-on control unit to turn on the electronic device upon receiving the turn-on signal; and a setting unit to initially set an operating condition of the electronic device on the basis of the user history associated with the user ID.

### Advantageous Effects of Invention

The present invention facilitates proper control of a plurality of electronic devices.

### BRIEF DESCRIPTION OF DRAWINGS

FIG. 1 is a system configuration diagram of an integrated electronic device system.

FIG. 2 is a screen diagram of an operation screen of a user terminal.

FIG. 3 is a functional block diagram of an integrated terminal in a first embodiment.

FIG. 4 is a functional block diagram of a user terminal.

FIG. 5 is a sequence diagram illustrating processes performed for newly registering an air conditioner in a device list.

FIG. 6 is a sequence diagram illustrating processes performed for turning on the air conditioner.

FIG. 7 is a functional block diagram of an integrated terminal according to a second embodiment.

FIG. 8 is a data structure table of utterance setting information.

FIG. 9 is a flowchart illustrating processes performed when an uttered command is detected.

FIG. 10 is a data structure table of life information.

FIG. 11 is a data structure table of basic setting information.

FIG. 12 is a flowchart illustrating processes performed when a user has got up and enters the living room.

FIG. 13 is a flowchart illustrating processes performed when a user goes to work by car.

FIG. 14 is a flowchart illustrating processes performed when a user leaves a living room.

FIG. 15 is a flowchart illustrating processes performed when entry is detected at an entrance.

FIG. 16 is a flowchart illustrating processes performed when a user comes home by car.

FIG. 17 is a data structure table of view setting information.

FIG. 18 is a flowchart illustrating processes performed when a user who has come home watches a TV program.

FIG. 19 is a functional block diagram of an electronic device relating to control performed by the integrated terminal.

FIG. 20 is a sequence diagram illustrating a method for transferring a control command by a relay method.

FIG. 21 is a schematic diagram for explaining inrush current.

FIG. 22 is a schematic diagram showing a change in current when an electronic device is turned off.

FIG. 23 is a flowchart illustrating processes performed by the integrated terminal for turning on an electronic device.

### DESCRIPTION OF EMBODIMENTS

An integrated electronic device system will now be described by referring to a first embodiment and a second embodiment. The first embodiment will be described assuming situations in which a plurality of electronic devices are controlled by a remote control. An integrated terminal (electronic device controller) in the first embodiment sets operating conditions of each electronic device on the basis of use history of the electronic device. The second embodiment will be described assuming situations in which an integrated terminal performs advance control of a plurality of electronic devices according to the user's lifestyle. The user can also convey his/her intention to the integrated terminal by using voice or the like.

Hereinafter, when the first and second embodiments are to be collectively referred or are not particularly distinguished from each other, each embodiment will be referred to as “the present embodiment”.

### First Embodiment

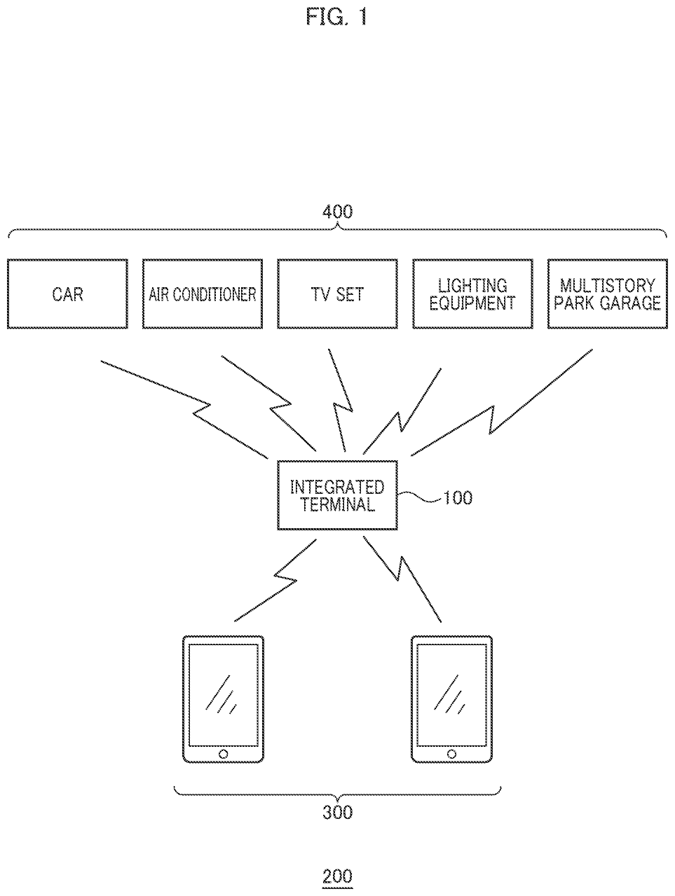

FIG. 1 is a system configuration diagram of an integrated electronic device system 200.

The integrated electronic device system 200 includes an integrated terminal 100, a plurality of user terminals 300, and a plurality of electronic devices 400. The user terminals 300 are communication terminals of users, and examples thereof include laptop PCs, tablet PCs, and smartphones. The user terminals 300 in the description of the present embodiment are assumed to be smartphones. Each user is identified by a “user ID”.

The electronic devices 400 are devices that can be electronically controlled (electronic devices) such as cars, air conditioning equipment (hereinafter referred to as “air conditioners”), television sets, lighting equipment, and multistory parking garages. In the first embodiment, each user can control a plurality of electronic devices 400 together by using the user terminal 300 and the integrated terminal 100.

The integrated terminal 100 (electronic device controller) is a relay device that receives control signals from the user terminals 300 and controls one or more electronic devices 400 in an integrated manner in accordance with the control signals. The integrated terminal 100 is installed in a house, and receives all of control signals from a plurality of user terminals 300 of a plurality of users. Control signals used herein refer to signals for remotely controlling the electronic devices 400 such as turning on, setting, and turning off the electronic devices 400.

In each user terminal 300, dedicated software (hereinafter referred to as “remote control software”) is pre-installed. The remote control software causes a plurality of buttons (operation interfaces) to be displayed on the screen of the user terminal 300, which will be described later. For example, when a user has touched a “got home” button displayed on the user terminal 300, a predetermined control signal associated with “got home” is transmitted together with the user ID from the user terminal 300 to the integrated terminal 100. The integrated terminal 100 turns on all of lighting equipment at the entrance, lighting equipment in the living room, and a TV set in the living room, for example, in response to the “got home” control signal. The user can turn on all of a plurality of electronic devices, which are the entrance light, the living room light, and the TV, only by touching the “got home” button.

The remote control software includes a voice recognition function. Thus, when a user has uttered the words “got home”, a control signal is similarly transmitted together with the user ID to the integrated terminal 100. In the case where utterance causes control of the electronic devices 400, the integrated terminal 100, instead of the user terminal 300, may detect the uttered voice and identify the user on the basis of the voice pattern of the uttered voice.

The remote control software may cause a “video” button to be displayed. When a user has touched the “video” button, the integrated terminal 100 may turn on the TV and a video (Blu-ray recorder) and set the input switch of the TV to “video”. When a user wants to watch a video, the user can start watching the video only with a single touch of the “video” button on the user terminal 300.

The remote control software may cause a “car” button to be displayed. When a user has touched the “car” button, the integrated terminal 100 transmits a control signal (start-engine instruction) to the car to start the engine of the car. In addition, the integrated terminal 100 also transmits a control signal (open-gate instruction) to an electric shutter of a garage to open the electric shutter. When a user goes out in a car, the user can readily take the car out only by touching the “car” button on the user terminal 300 and getting into the car without additionally operating the electric shutter.

Alternatively, when the “car” button is touched, the integrated terminal 100 may start the car engine, which may be a trigger for opening the electric shutter. For example, the car may transmit an open-gate signal to the electric shutter when the engine is started, and the electric shutter may start an opening operation upon receiving the open-gate signal. Alternatively, the electric shutter may have a sound recognition function to start an opening operation upon detecting an engine revving sound of the car.

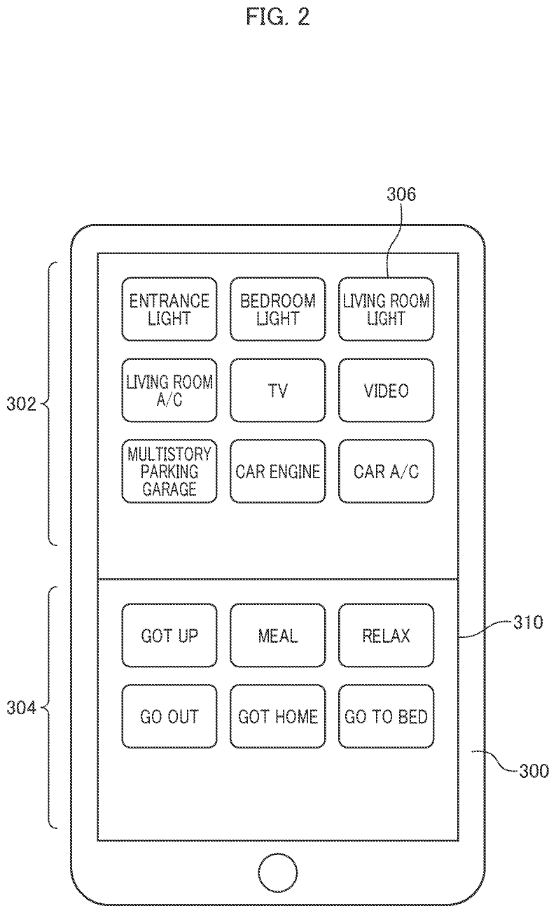

FIG. 2 is a screen diagram of an operation screen of a user terminal 300.

The remote control software causes an operation screen 310 including a plurality of turn-on buttons 306 to be displayed. The operation screen 310 includes a device operation region 302 and a scene operation region 304. The device operation region 302 includes turn-on buttons 306 associated with electronic devices. The scene operation region 304 includes turn-on buttons 306 associated with scenes. A scene is a concept expressing a situation of a user such as “got home” as described above. Each turn-on button may display words uttered by a user in a corresponding scene, such as “good morning”, “let's eat”, “I'm off”, “I'm home”, and “good night”, or may be an icon associated with a corresponding scene.

As described above, when the user has touched a turn-on button 306, a turn-on signal associated with the turn-on button 306 is transmitted from the user terminal 300 to the integrated terminal 100. Similarly, when the user has uttered a predetermined voice associated with a turn-on button 306, a turn-on signal associated with the turn-on button 306 is transmitted to the integrated terminal 100. The turn-on buttons 306 or predetermined voices associated with the turn-on buttons 306 are triggers for turning on various electronic devices 400. Hereinafter, a user interface that generates a turn-on signal will be referred to as a “turn-on interface”. A turn-on interface may be a touch button like the turn-on buttons 306 or may be a sound/voice recognition type interface. The user can turn on a plurality of electronic devices 400 with a single user terminal 300 by touching the turn-on buttons 306.

In the first embodiment, assume that the integrated terminal 100 provides the operation screen 310 in a form of a web page to each user terminal 300.

Note that the operation screen 310 may include not only turn-on buttons 306 but also various setting buttons (not illustrated). For example, when the turn-on buttons 306 of an air conditioner is touched, various setting buttons for setting the temperature, the air volume, and the like may be displayed. Alternatively, the turn-on buttons 306 may be buttons for various settings.

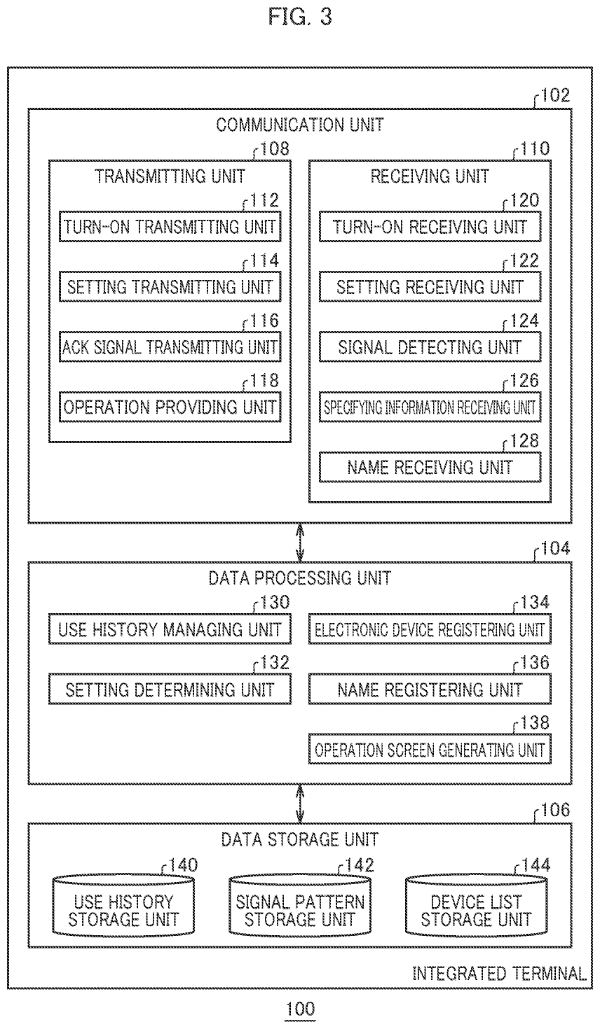

FIG. 3 is a functional block diagram of the integrated terminal 100 in the first embodiment.

Respective components of the integrated terminal 100 are implemented by hardware including arithmetic units such as central processing units (CPUs) and various co-processors, storage devices such as memories and storages, and wire or wireless communication lines connecting the components, and by software, stored in the storage devices, for supplying processing instructions to the arithmetic units. Computer programs may be constituted by device drivers, an Operating System, various application programs on upper layers thereof, and libraries providing common functions to the programs.

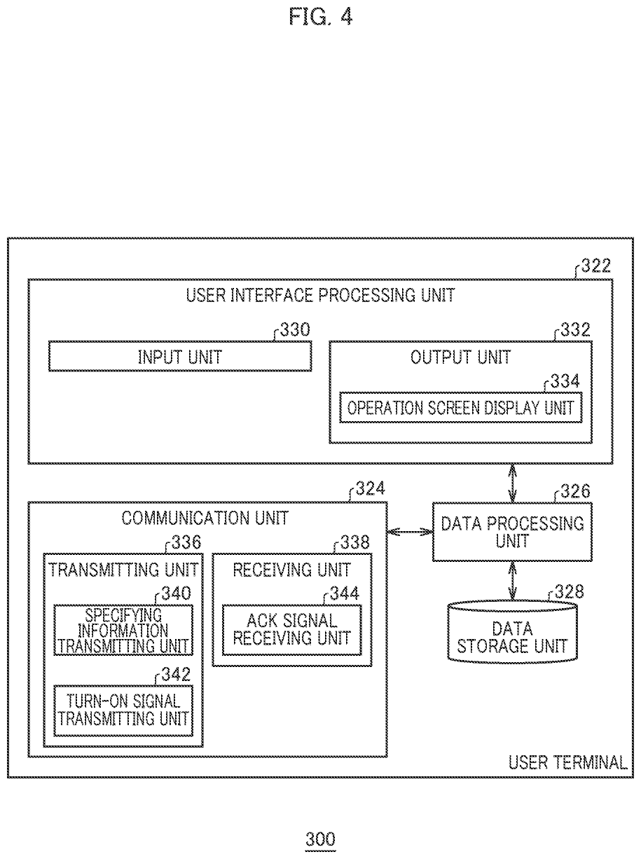

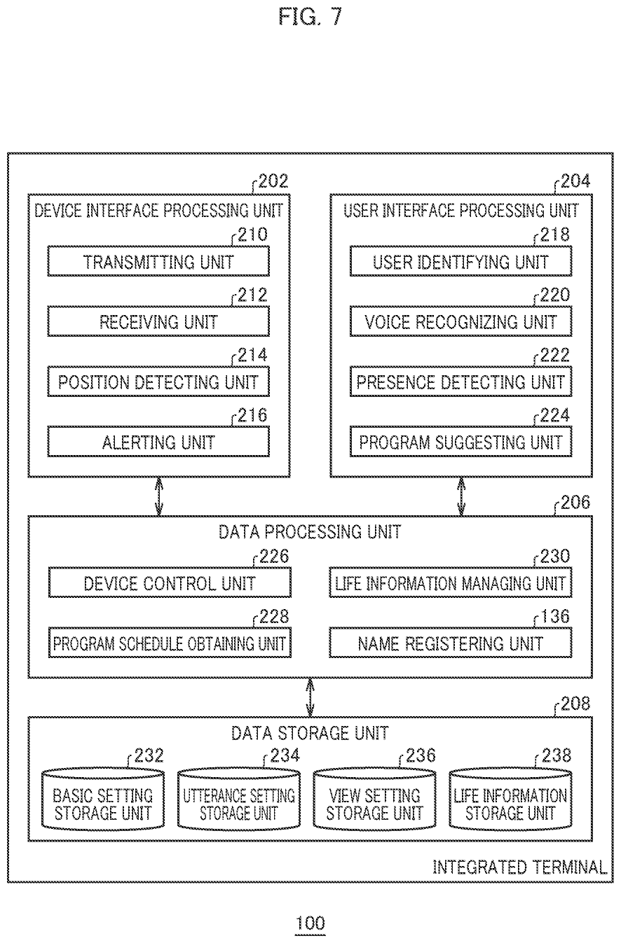

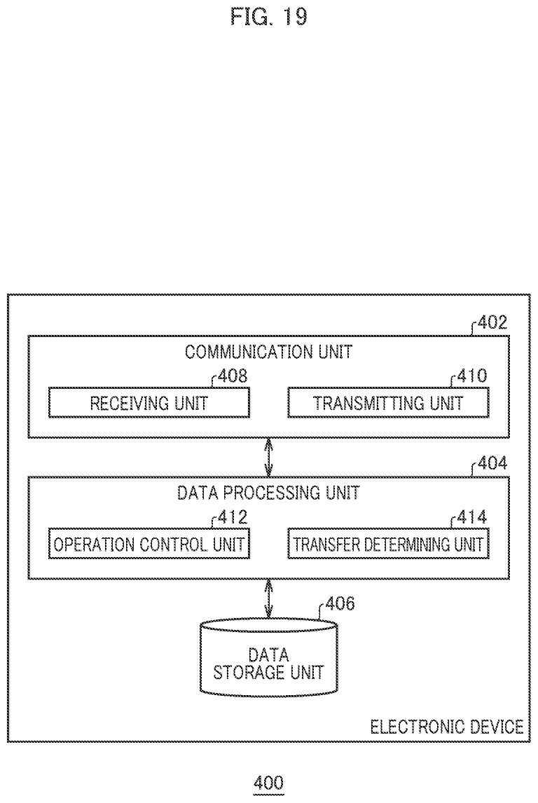

The blocks described below are not in units of hardware but are in units of functions. The same applies to the user terminal 300 illustrated in FIG. 4, the integrated terminal 100 in the second embodiment illustrated in FIG. 7, and the electronic device 400 illustrated in FIG. 19.

The integrated terminal 100 includes a communication unit 102, a data processing unit 104, and a data storage unit 106.

The communication unit 102 performs processing for communication with the user terminals 300 and the electronic devices 400 via a communication network. The data storage unit 106 stores various information data. The data processing unit 104 performs various processes on the basis of data obtained by the communication unit 102 and data stored in the data storage unit 106. The data processing unit 104 also functions as an interface of the communication unit 102 and the data storage unit 106.

The communication unit 102 includes a transmitting unit 108 for transmitting various information data to external devices (the user terminals 300 and the electronic devices 400), and a receiving unit 110 for receiving various information data from the external devices.

The transmitting unit 108 includes a turn-on transmitting unit 112, a setting transmitting unit 114, an acknowledgement signal transmitting unit 116, and an operation providing unit 118. The turn-on transmitting unit 112 transmits first turn-on signals for turning on the electronic devices 400. The setting transmitting unit 114 transmits first setting signals for setting the operations of various electronic devices 400, such as the temperature of an air conditioner, the channel of a TV program, and the brightness of the living room light, to the electronic devices 400. The acknowledgement signal transmitting unit 116 transmits acknowledgement signals to the user terminals 300, which will be described later. The operation providing unit 118 transmits web pages presenting the operation screen 310 to the user terminals 300.

The receiving unit 110 includes a turn-on receiving unit 120, a setting receiving unit 122, a signal detecting unit 124, a specifying information receiving unit 126, and a name receiving unit 128.

The turn-on receiving unit 120 receives second turn-on signals for turning on the electronic devices 400 from the user terminals 300. Note that the second turn-on signals transmitted from the user terminals 300 to the integrated terminal 100 cannot turn on the electronic devices 400. Upon receiving a second turn-on signal from a user terminal 300, the turn-on transmitting unit 112 converts the second turn-on signal into a first turn-on signal supported by the corresponding electronic device 400 and then transmits the first turn-on signal to the electronic device 400. Thus, the user terminals 300 cannot control the electronic devices 400 without the integrated terminal 100. When the first turn-on signals and the second turn-on signals are to be collectively referred or are not particularly distinguished from each other, these signals will be simply referred to as “turn-on signals”.

The setting receiving unit 122 receives second setting signals for setting the operations of the electronic devices 400 from the user terminals 300. In a manner similar to the turn-on signals, the second setting signals transmitted from the user terminals 300 to the integrated terminal 100 cannot change the settings of the electronic devices 400. Upon receiving a second setting signal from a user terminal 300, the setting transmitting unit 114 converts the second setting signal into a first setting signal and then transmits the first setting signal to the corresponding electronic device 400. When the first setting signals and the second setting signals are to be collectively referred or are not particularly distinguished from each other, these signals will be simply referred to as “setting signals”. In addition, the turn-on signals and the setting signals will be collectively referred to as “control signals”.

The signal detecting unit 124 detects control signals from remote controls dedicated for the electronic devices 400. The specifying information receiving unit 126 receives specifying information for specifying an electronic device 400 from a user terminal 300, which will be described later. The name receiving unit 128 receives specification of the operation name of a turn-on interface in the scene operation region 304 from a user terminal 300.

The data storage unit 106 includes a use history storage unit 140, a signal pattern storage unit 142, and a device list storage unit 144.

The use history storage unit 140 manages use histories of the electronic devices 400 for each user. For example, as a use history of an air conditioner used by a user P1, such information as a 60% or higher likelihood of turning on the heater in a time period of 18:00 to 19:00 in January and a 55% likelihood of setting the temperature of the heater to 25° C. The signal pattern storage unit 142 stores signal patterns of the control signals (example: first turn-on signal, first setting signal) for the electronic devices 400.

The “signal patterns” used herein may be waveforms and frequencies of control signals. For example, the waveform of a digital signal include in the turn-on signal for an air conditioner X is registered. Upon capturing an unknown control signal, the signal detecting unit 124 determines that the control signal is a turn-on signal for the air conditioner X (that the control signal is known) if the waveform of the control signal corresponds to the waveform of the turn-on signal for the air conditioner X.

The device list storage unit 144 manages a list of electronic devices 400 to be controlled as a device list. In the present embodiment, the device list storage unit 144 manages a device list for each user.

The data processing unit 104 includes a use history managing unit 130, a setting determining unit 132, an electronic device registering unit 134, a name registering unit 136, and an operation screen generating unit 138.

The use history managing unit 130 manages use histories for each combination of a user and an electronic device 400. The setting determining unit 132 determines a set value of an electronic device 400 on the basis of the use histories. The electronic device registering unit 134 registers electronic devices 400 in the device list. The operation screen generating unit 138 generates web pages for the operation screens 310.

FIG. 4 is a functional block diagram of a user terminal 300.

As described above, it is assumed in the description of the first embodiment that the functions shown in FIG. 4 are implemented by remote control software installed in typical smartphones.

The user terminal 300 includes a user interface processing unit 322, a communication unit 324, a data processing unit 326, and a data storage unit 328.

The user interface processing unit 322 receives operations performed by the user, and performs processing relating to a user interface such as image display and audio output. The communication unit 324 performs processing for communication with the integrated terminal 100 via a wireless communication network. The data storage unit 328 stores various data. The data processing unit 326 performs various processes on the basis of data obtained by the user interface processing unit 322 and the communication unit 324 and data stored in the data storage unit 328. The data processing unit 326 also functions as an interface of the user interface processing unit 322, the communication unit 324, and the data storage unit 328.

The user interface processing unit 322 includes an input unit 330 and an output unit 332. The input unit 330 receives various operations performed by the user. The input unit 330 can also receive voice input from the user. The output unit 332 outputs various types of information in the form of images, audio, and the like. The output unit 332 includes an operation screen display unit 334. The operation screen display unit 334 displays the input unit 330.

The communication unit 324 includes a transmitting unit 336 for transmitting various information data to the integrated terminal 100, and a receiving unit 338 for receiving various information data from the external devices.

The transmitting unit 336 includes a specifying information transmitting unit 340 and a turn-on signal transmitting unit 342. The specifying information transmitting unit 340 transmits specifying information indicating the name of an electronic device 400. The turn-on signal transmitting unit 342 transmits a second turn-on signal to the integrated terminal 100. The second turn-on signal includes the user ID and the device ID of the electronic device 400 to be controlled. The receiving unit 338 includes an acknowledgement signal receiving unit 344. The acknowledgement signal receiving unit 344 receives an acknowledgement signal from the integrated terminal 100.

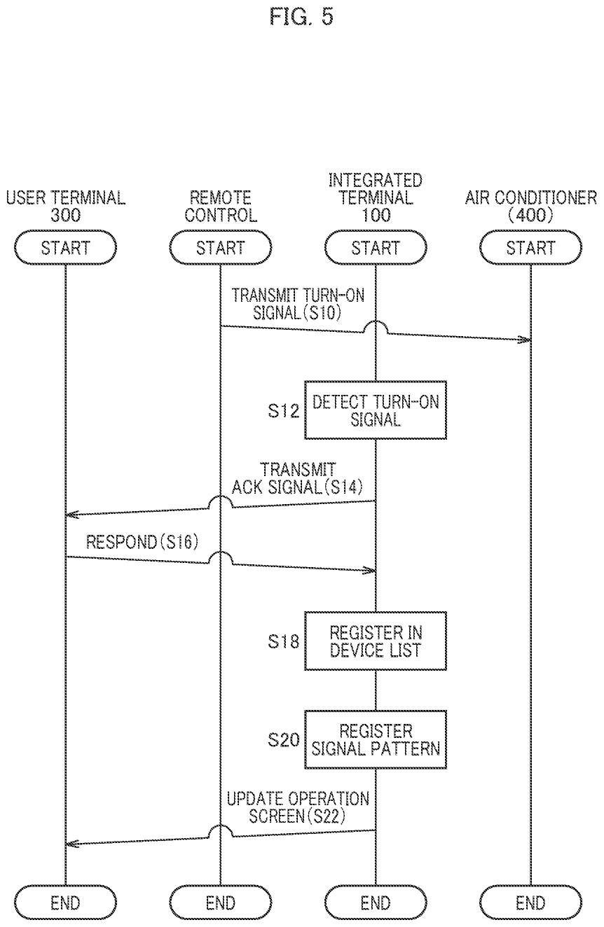

FIG. 5 is a sequence diagram illustrating processes performed for newly registering an air conditioner in the device list.

In the description, assume processes for making the integrated terminal 100 recognize an air conditioner (electronic device 400) that is newly purchased. Similar processes are performed when the integrated terminal 100 is newly installed. First, the user manipulates a remote control that comes with the air conditioner to transmit a first turn-on signal to the air conditioner (S10). The air conditioner is turned on by the first turn-on signal.

The signal detecting unit 124 of the integrated terminal 100 captures the first turn-on signal (an infrared signal, for example) (S12). In the signal pattern storage unit 142, information on signal patterns, that is, frequencies and waveforms of control signals (turn-on signals and setting signals) for various electronic devices 400 are registered in advance. Herein, assume that the signal pattern detected in S10 has not been registered. In this case, the acknowledgement signal transmitting unit 116 transmits an acknowledgement signal to the user terminal 300 (S14). The acknowledgement signal is simultaneously transmitted (broadcast) to the user terminals 300 within a predetermined range from the integrated terminal 100.

Upon receiving the acknowledgement signal, the user responds to the acknowledgement signal by returning specifying information that specifies the name “air conditioner” of the electronic device 400 (S16). The specifying information transmitting unit 340 transmits the specifying information including the user ID and the name “air conditioner” to the integrated terminal 100. The electronic device registering unit 134 sets a device ID for the “air conditioner” and registers the user ID and the device ID of the “air conditioner” in association with each other in the device list (S18). In addition, the electronic device registering unit 134 registers the signal pattern of the first turn-on signal detected in S12 in association with the device ID of the air conditioner in the signal pattern storage unit 142 (S20).

The operation screen generating unit 138 of the integrated terminal 100 newly generates an operation screen 310 including the turn-on interface of the “air conditioner”. The operation providing unit 118 transmits a webpage of the generated operation screen 310 to the user terminals 300 (S22) In this process, the user terminals 300 are also notified of the device ID from the integrated terminal 100.

As described above, upon capturing the first turn-on signal, the integrated terminal 100 can register the “air conditioner” that has been newly purchased after checking with the user. In addition, as a result of turning on the air conditioner with the dedicated remote control, the user can obtain an operation screen 310 (turn-on interface) for operating the air conditioner with the user terminal 300 thereafter.

Each time a control signal is captured, the electronic device registering unit 134 determines whether the control signal matches any of the registered signal patterns. If the signal pattern of the control signal is not registered, the processes in S12 and subsequent steps are performed, and the signal pattern is learned in S20. Similar processes are also performed for a first setting signal. The integrated terminal 100 also check with the user when a second setting signal with a new (unregistered) signal pattern is captured.

Before new registration of an air conditioner, confirmation on the registration may be sought from the user. Specifically, at the same time as transmitting the acknowledgement signal in S14 or after receiving the specifying information in S16, the transmitting unit 108 of the integrated terminal 100 may transmit a message saying “Register new appliance?” to the user. The electronic device registering unit 134 may register the air conditioner in the device list on condition that approval for the registration is received from the user.

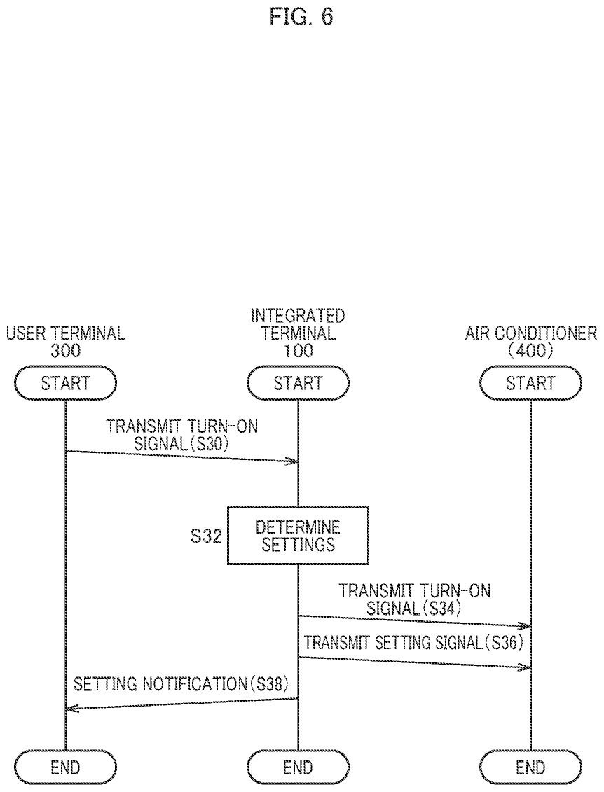

FIG. 6 is a sequence diagram illustrating processes performed for turning on the air conditioner.

Assume that the user has first selected the air conditioner on the operation screen 310 of the user terminal 300. The turn-on signal transmitting unit 342 of the user terminal 300 transmits a second turn-on signal together with the user ID and the device ID to the integrated terminal 100 (S30). The turn-on receiving unit 120 of the integrated terminal 100 receives the second turn-on signal.

The setting determining unit 132 refers to the user's use history of the air conditioner, and determines set values for the air conditioner. For example, assume that the outdoor temperature in a time period of 18:00-19:00 in which the second turn-on signal is transmitted is 30° C. or higher. When the number of times “25° C.” and “high air volume” were set under the same condition in the part is the largest, the setting determining unit 132 determines that “25° C.” and “high air volume” are suitable set values for the air conditioner (S32).

The turn-on transmitting unit 112 transmits a first turn-on signal to the air conditioner (S34). Subsequently, the setting transmitting unit 114 transmits setting signals for set values of “25° C.” and “high air volume” to the electronic device 400 (S36). The transmitting unit 108 of the integrated terminal 100 transmits a text message indicating the settings to the user terminal 300 (S38). According to such a control method, the user can turn on the air conditioner with optimum set values based on previous use histories only by instructing to turn on the air conditioner.

The user can also change the set values. For example, when the user has uttered “it's a little hot” or when the user has touched “lower temperature” button on the user terminal 300, specified setting information indicating a temperature lowering request is transmitted from the user terminal 300 to the integrated terminal 100. In this case, the setting determining unit 132 determines that “24° C.”, which is lower than “25° C.” by one degree, is “more suitable”, and the setting transmitting unit 114 instructs to lower the set temperature of the air conditioner by one degree. In addition, the use history managing unit 130 updates the user's use history of the air conditioner on the basis of the new settings.

The setting determining unit 132 determines an average of various temperatures set under an external condition of “an outdoor temperature of 30° C. or higher in a time period of 18:00-19:00” to be “a suitable set temperature based on the use history”. For example, in the case of the example described above, when the user has specified “24° C.”, the setting determining unit 132 may determine “24.5° C.”, which is an average of “24° C.” and “25° C.”, to be the right set temperature based on the use history at next and subsequent determinations. The same applies to the air volume.

The integrated terminal 100 may be always on, or may be turned on by a turn-on signal from a user terminal 300. In this case, the operation providing unit 118 of the integrated terminal 100 transmits an operation screen 310 to the user terminal 300 that is the source of turn-on instruction. Alternatively, the operation providing unit 118 notifies the user terminal 300 of an URL for displaying the operation screen 310. The user can click the URL to display the operation screen 310 on a web browser.

It is also possible to turn on a plurality of electronic devices 400 at the same time. For example, assume that the user has turned on a TV with a remote control for the TV and has subsequently turned on an air conditioner with a remote control for the air conditioner. For turning on the air conditioner and the TV in this case, a user terminal 300 may be used instead of the dedicated remote controls. Thereafter, the user inputs an operation name. Assume, for example, that the user has input a name “relax”. The specifying information transmitting unit 340 of the user terminal 300 transmits name information including an operation name “relax” together with the user ID to the integrated terminal 100.

The name receiving unit 128 of the integrated terminal 100 receives the name information. The fact that the TV and the air conditioner were turned on within a predetermined period, such as within 10 seconds, before the name information is received is detected by the signal detecting unit 124. In this case, the name registering unit 136 sets a command ID for the name “relax”, and associates the command ID with the “TV” and the “air conditioner”. The operation screen generating unit 138 generates an operation screen 310 including a “relax” button for the user.

Thereafter, the user can turn on the TV and the air conditioner at the same time by touching the “relax” button displayed on the operation screen 310 (see FIG. 2). More specifically, assume that the user has touched the “relax” button, for example. In this case, the second turn-on signal (a multi-turn-on signal) is transmitted together with the command ID associated with “relax” from the user terminal 300 to the integrated terminal 100. The setting determining unit 132 recognizes that the devices to be turned on by this command ID are the “TV” and the “air conditioner”. The setting determining unit 132 sets an appropriate channel on the basis of the use history of the TV. Similarly, the setting determining unit 132 sets the temperature and the like of the air conditioner on the basis of the use history of the air conditioner.

For example, assume that, in a certain time period, the probability that a TV program A is selected is 60% and the probability that a TV program B is selected is 40%. In this case, the setting determining unit 132 selects the TV program A when the TV is turned on. Assume that the user specifies the TV program B rather than the TV program A at this point. As a result, assume that, in this time period, the probability that the TV program A is selected changes to 50% and the probability that the TV program B is selected changes to 50%. In this case, in this time period, the setting determining unit 132 thereafter selects the TV program B, which has recently been selected, with priority.

A use history is a combination of a user, a time period, an external environment, a device ID (electronic devices 400), and operating conditions. The “external environment” refers to outdoor temperature, humidity, presence/absence of noise, and the like that show the states of environment surrounding a user. The use history managing unit 130 recognizes the external environment by using various sensors installed indoors and outdoors. The operating conditions refer to various set values of the set temperature, a timer, a channel, and the like for controlling an electronic device 400. The use history managing unit 130 updates the use history of each user as appropriate on the basis of operations performed on the electronic device 400 by the user.

For example, assume that the user entered the living room at eleven o'clock and turned on the air conditioner. Assume that the outdoor temperature at this time was 28° C. According to a previous use history, when the outdoor temperature was around 28° C. (around 26 to 30° C., for example) at eleven o'clock, the room temperature was set to 25 to 28° C. and the average of the set temperatures was 26° C. In this case, the setting determining unit 132 may set the set temperature of the air conditioner to 26° C.

Assume that the user has operated the user terminal 300 to change the set temperature of the air conditioner to “25° C.”. In this case, the use history managing unit 130 updates the use history. As a result of updating the use history, the setting determining unit 132 may set the set temperature of the air conditioner to be lower than 26° C. next and subsequent times under the same condition. In this manner, the use history managing unit 130 updates the use history on the basis of the user's operations, and the setting determining unit 132 controls the electronic device 400 on the basis of the use history.

### Second Embodiment

A hardware configuration of an integrated electronic device system 200 according to a second embodiment is similar to that in the first embodiment (see FIG. 1). The first embodiment has been described assuming the situations in which various electronic devices 400 are controlled by the user terminals 300 via the integrated terminal 100. In the second embodiment, the integrated terminal 100 obtains a user's lifestyle and performs advance control on the electronic devices 400 before the user gives instructions. In addition, the user can intervene to change various settings provided by the integrated terminal 100 by using voice or the user terminal 300. In the second embodiment, the intervention using voice will be mainly described.

In the second embodiment, control performed by the integrated terminal 100 assuming a day of a user with a user ID P01 (hereinafter referred to as a “user (P01)”) from getting up in the morning to going to bed will be described.

FIG. 7 is a functional block diagram of the integrated terminal 100 according to the second embodiment.

While functional blocks that are necessary for implementing the control in the second embodiment will be described with reference to FIG. 7, the integrated terminal 100 in the second embodiment may include all or some of the functional blocks of the integrated terminal 100 described in the first embodiment.

The integrated terminal 100 includes a device interface processing unit 202, a user interface processing unit 204, a data processing unit 206, and a data storage unit 208.

The device interface processing unit 202 performs processing for communication with the electronic devices 400 or the user terminals 300 by wireless communication. The user interface processing unit 204 performs processing relating to the interface with the user using voice, wireless communication, or the like. The data storage unit 208 stores various information data. The data processing unit 206 performs various processes on the basis of data obtained by the device interface processing unit 202 and the user interface processing unit 204 and data stored in the data storage unit 208. The data processing unit 206 also functions as an interface of the device interface processing unit 202, the user interface processing unit 204, and the data storage unit 208.

The device interface processing unit 202 includes a transmitting unit 210, a receiving unit 212, a position detecting unit 214, and an alerting unit 216.

The transmitting unit 210 transmits various signals to the electronic devices 400 and the user terminals 300. The receiving unit 212 receives various signals from the electronic devices 400 and the user terminals 300. The position detecting unit 214 detects the position of a car (one of electronic devices 400) that has been registered in advance. The position detecting unit 214 may detect the position of the by known means such as a global positioning system (GPS) or may receive a signal indicating the position from the car. The alerting unit 216 causes an alarm device (not illustrated) to operate by transmitting an alert signal to the alarm device.

The user interface processing unit 204 includes a user identifying unit 218, a voice recognizing unit 220, a presence detecting unit 222, and a program suggesting unit 224.

The user identifying unit 218 identifies the user ID of a user present in a predetermined space such as a living room, an entrance, or the like. The user identifying unit 218 may identify a user by receiving notification of the user ID from the user terminal 300 of the user via near field communication means such as Bluetooth (registered trademark). Alternatively, the user identifying unit 218 may image a user with a camera installed in advance and identify the user ID through face recognition on the taken image.

The voice recognizing unit 220 identifies the content and the utterer of an uttered command. An uttered command refers to a voice command for controlling electronic devices 400. The voice recognizing unit 220 performs voice recognition on an uttered command to identify the command ID and also recognize words included in the uttered command. For example, when the user has uttered “it's a little hot”, the voice recognizing unit 220 recognizes the words “a little” and “hot” by voice recognition.

The presence detecting unit 222 detects the presence or the absence of a user in a predetermined space (examples: a living room, a study, an entrance). The presence detecting unit 222 detects entry and exit of a user to and from the predetermined space by a motion detector or Light Detection and Ranging (LiDAR), for example. When a user is present, the user identifying unit 218 identifies the user ID. The user identifying unit 218 obtains the user IDs of users associated with the space for presence/absence detection in advance. The program suggesting unit 224 suggests a TV program according to the user's preference by referring to view setting information (to be described later) of the user.

The data storage unit 208 includes a basic setting storage unit 232, an utterance setting storage unit 234, a view setting storage unit 236, and a life information storage unit 238.

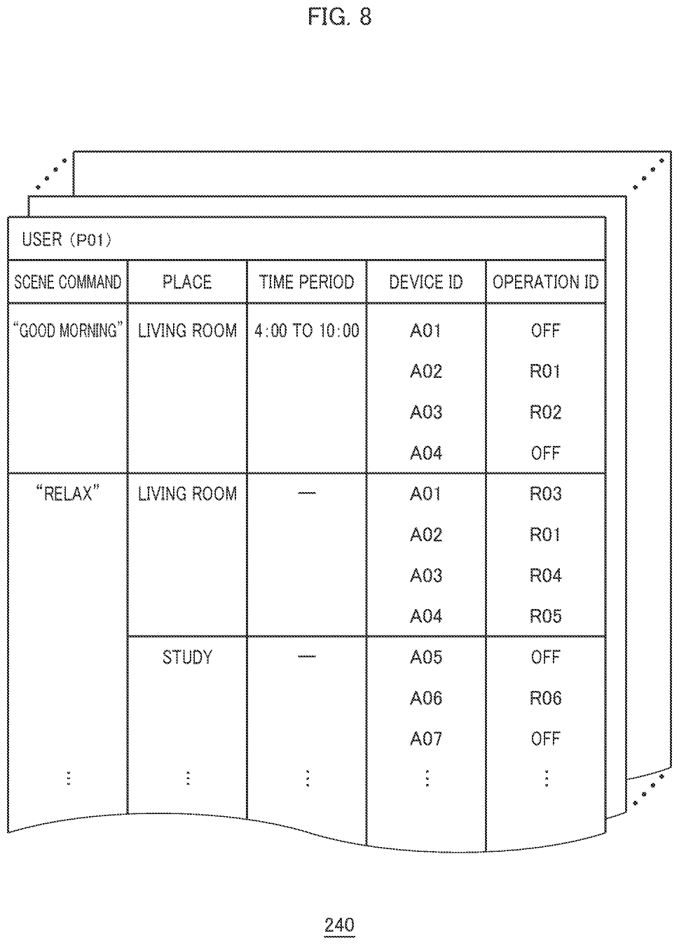

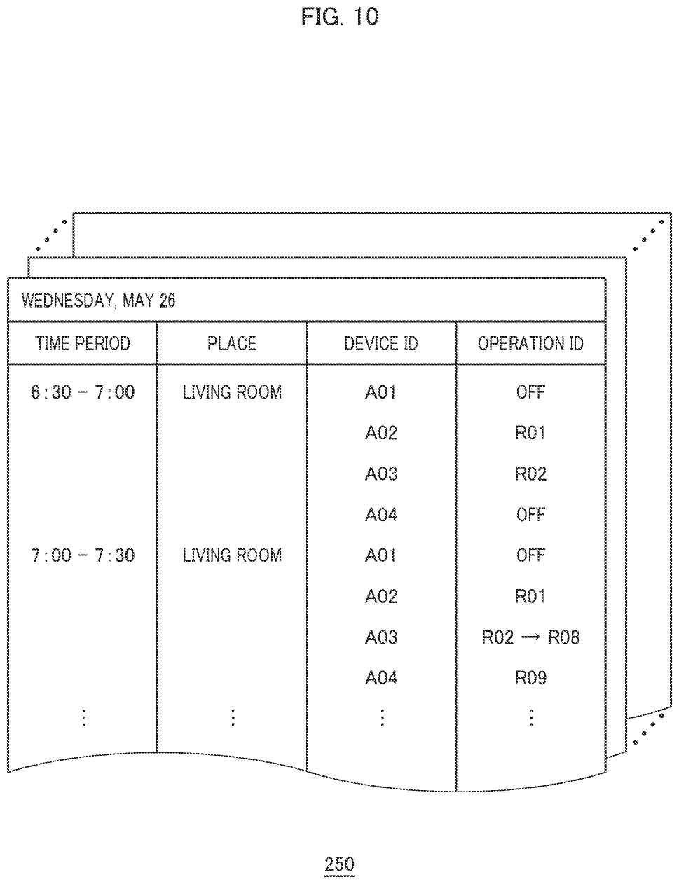

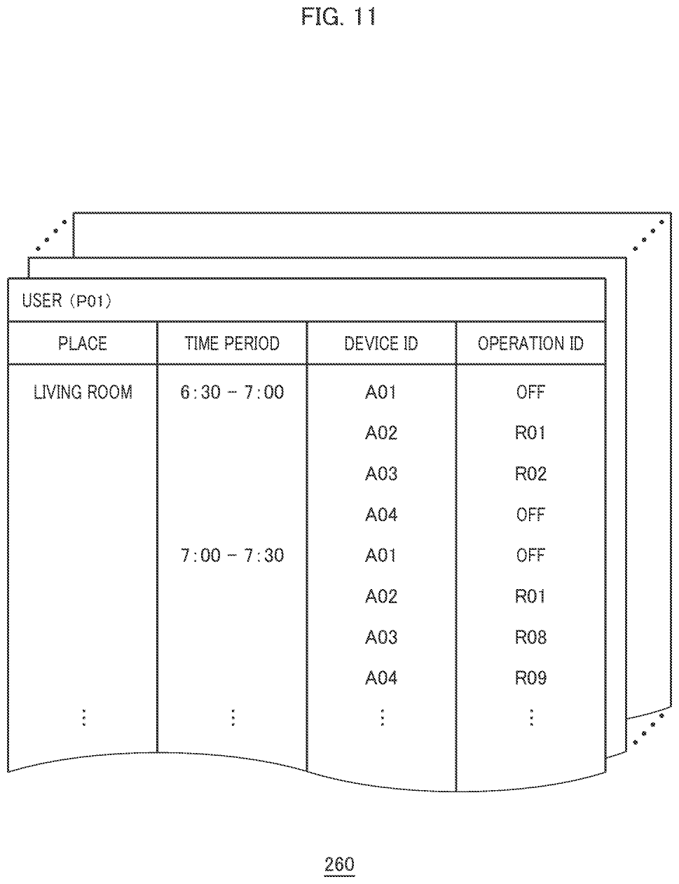

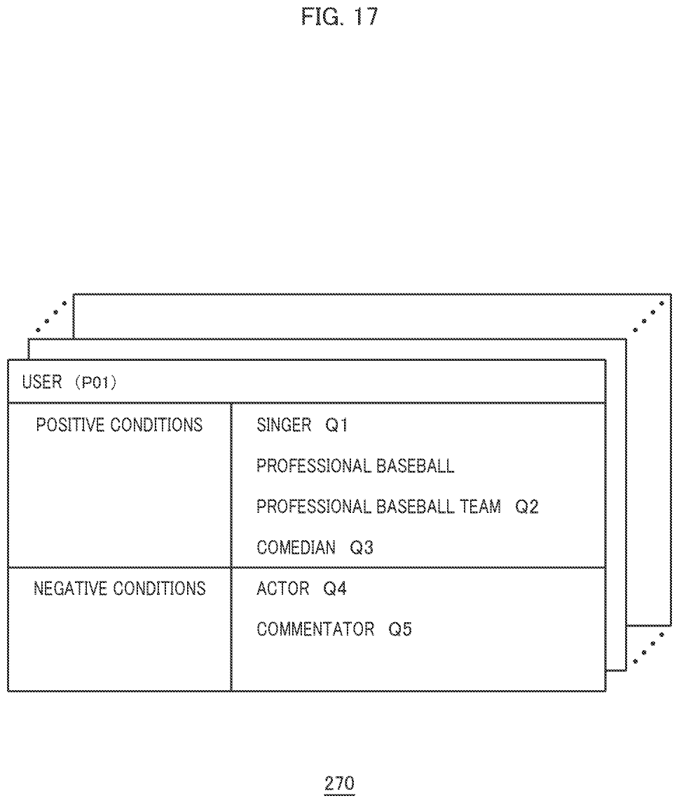

The basic setting storage unit 232 stores basic setting information. The basic setting information will be described later with reference to FIG. 11. The utterance setting storage unit 234 stores utterance setting information. The utterance setting information will be described later with reference to FIG. 8. The view setting storage unit 236 stores view setting information. The view setting information will be described later with reference to FIG. 17. The life information storage unit 238 stores life information. The life information will be described later with reference to FIG. 10.

The data processing unit 206 includes a device control unit 226, a program schedule obtaining unit 228, the name registering unit 136, and a life information managing unit 230.

The device control unit 226 controls the electronic devices 400 on the basis of the basic setting information. The program schedule obtaining unit 228 obtains a television schedule via the Internet. The life information managing unit 230 manages the life information, which will be described later.

FIG. 8 is a data structure table of utterance setting information 240.

The utterance setting information 240 is provided for each user, and defines uttered commands each associated with a scene and operating conditions of various electronic devices 400 associated with each uttered command. FIG. 8 illustrates the utterance setting information 240 for the user (P01). Hereinafter, among various uttered commands, uttered commands predefined in association with corresponding scenes will be referred to as “scene commands”. Each scene command is identified by a command ID as described above.

The name registering unit 136 registers each scene command, such as “relax” in association with a command ID. In the utterance setting information 240, four electronic devices 400 (A01), (A02), (A03), and (A04) and operating conditions for the respective electronic devices 400 (A01), (A02), (A03), and (A04) are associated with a scene command “good morning”, a place of presence “living room”, and a time period “4:00 to 10:00” of the user (P01). The operating condition of the electronic device 400 (A01) is “off”. Thus, when the user (P01) has uttered “good morning” in the living room during the aforementioned time period, the device control unit 226 powers off the electronic device 400 (A01). For example, in a case where the electronic device 400 (A01) is “lighting equipment”, the device control unit 226 sets the lighting equipment to an off state.

The operating conditions are each associated with an “operation ID”. The device control unit 226 registers an operation ID and an operating condition in association with each other in advance. For the aforementioned scene, an operating condition (R01) is set to the electronic device 400 (A02). For example, assume that the electronic device 400 (A02) is an air conditioner and that the operating condition (R01) is “dehumidifying for 10 minutes only and setting the set temperature to 25° C.”. In this case, when the user (P01) has uttered “good morning” in the living room during the aforementioned time period, the device control unit 226 gives setting instructions to “humidify for 10 minutes only and set the set temperature to 25° C.” to the air conditioner. The same applies to the electronic device 400 (A03) and the electronic device 400 (A04). In this manner, when the user (P01) has uttered “good morning” in the living room during the aforementioned time period, the integrated terminal 100 simultaneously and automatically controls the four electronic devices 400.

When the user (P01) has uttered “good morning” during a time period other than the aforementioned time period “4:00 to 10:00”, the integrated terminal 100 performs no processing. This is because nothing relating to the control of electronic devices 400 in such a case is defined in the utterance setting information 240. Similarly, when the user (P01) has uttered “good morning” in a place other than the living room, the integrated terminal 100 performs no processing.

When the user (P01) has uttered “relax” in the living room, the device control unit 226 controls the electronic device 400 (A01) in accordance with an operating condition (R03) regardless of the time period of the utterance. For example, the electronic device 400 (A01) may be “lighting equipment” and the operating condition (R03) may be “turning the light on at 20% illuminance”. Similarly, the device control unit 226 controls the electronic device 400 (A02), the electronic device 400 (A03), and the electronic device 400 (A04) in accordance with the operating condition (R01), an operating condition (R04), and an operating condition (R05), respectively.

When the user (P01) has uttered “relax” in the study, the device control unit 226 controls electronic devices 400 (A05), (A06), and (A07). In this manner, the utterance setting information 240 defines which of the electronic devices 400 and how the device control unit 226 controls depending on the user, the scene command (command ID), the place, and the time period.

In a case where an electronic device 400 is an “air conditioner”, whether or not to dehumidify, the set temperature, the air direction, the air volume, and the like are set as an operating condition. In a case where an electronic device 400 is an electrically controllable “window”, whether to unlock or lock, the window opening degree, and the like are defined as an operating condition. Examples of the electronic devices 400 also include electric curtains, a TV set, audio equipment, and lighting equipment.

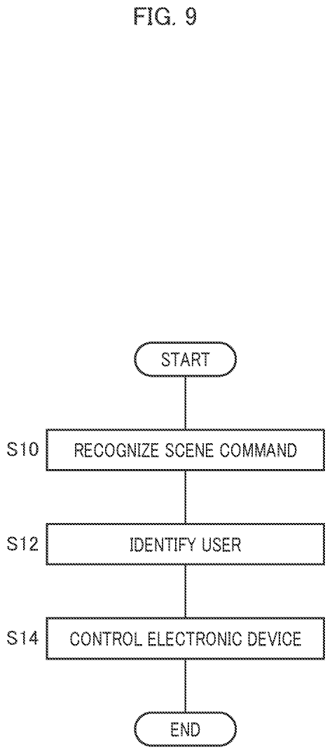

FIG. 9 is a flowchart illustrating processes performed when an uttered command is detected.

Here, assume a scene in which the user (P01) enters the living room and uttered “good morning” during a time period of “4:00 to 10:00” (also see FIG. 8). When the user (P01) enters the living room, the presence detecting unit 222 detects the entry, and the user identifying unit 218 identifies the user ID=P01 of the user present in the living room. The user identifying unit 218 holds all the user IDs associated with the living room. Because there may be a plurality of people present in the living room, it is necessary to identify the utterer of the scene command “good morning” in order to respond to the scene command.

The voice recognizing unit 220 captures voice by a microphone, recognizes the uttered command “good morning”, and identifies the command ID. In other words, the voice recognizing unit 220 recognizes a scene command (S10). Subsequently, the voice recognizing unit 220 identifies the user ID of the utterer on the basis of the features of the uttered voice (S12). Specifically, the voice recognizing unit 220 compares the voice features of the scene command with the voice features of one or more people present in the living room identified by the user identifying unit 218 to identify the utterer from among the one or more people present in the living room. In a case where there is only one person in the living room, the voice recognizing unit 220 identifies the only person present in the living room as the utterer without performing the voice comparing process. The device control unit 226 refers to the utterance setting information 240, identifies the electronic devices 400 to be controlled, and controls the electronic devices 400 in accordance with the operating conditions of the identified electronic devices 400 (S14).

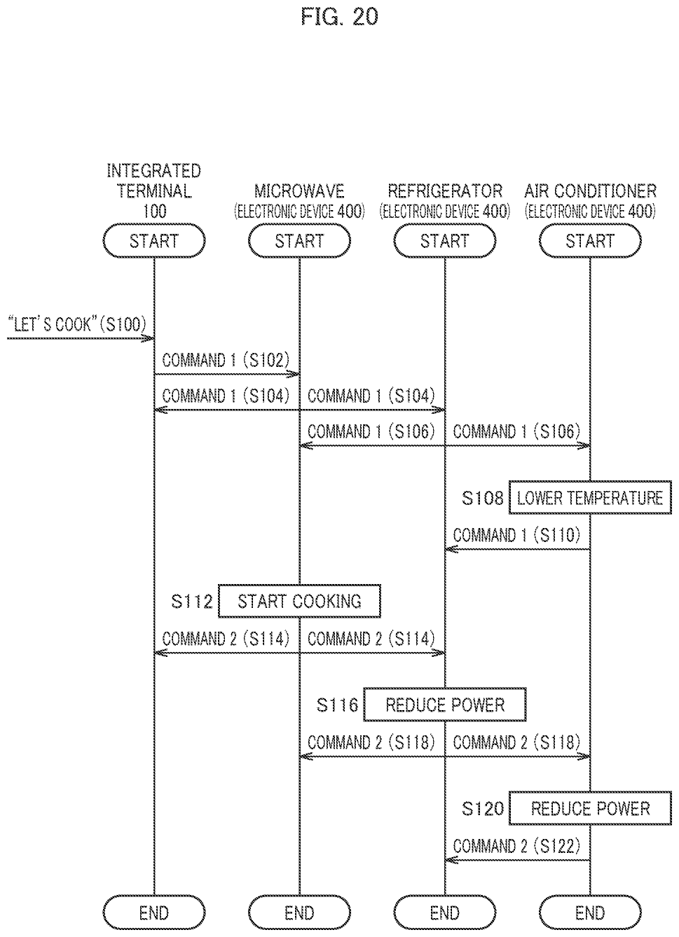

The integrated terminal 100 transmits a control signal to each of the electronic devices 400 to simultaneously control the electronic devices 400. The integrated terminal 100 may transmit the control signals to the electronic devices 400 over a Long Term Evolution (LTE) network. The integrated terminal 100 may directly transmit the control signals to the electronic devices 400 by near field communication means such as Bluetooth (registered trademark) or may transmit the control signals to the electronic devices 400 by relay of the control signals between a plurality of electronic devices 400. The relay method will be described later with reference to FIG. 20.

FIG. 10 is a data structure table of life information 250.

The life information managing unit 230 detects behaviors of users by various sensors such as cameras, motion detectors, microphones, LiDAR, thermal sensors, and the like installed indoors and outdoors, and registers the users' lifestyles as life information 250. The life information 250 is provided for each user, and includes records of the operating conditions of the electronic devices 400 depending on the time period and the place. FIG. 10 illustrates the life information 250 on Wednesday, May 26 of the user (P01). The life information is similar to the use history in the first embodiment.

For example, during a time period “6:30 to 7:00” on Wednesday, May 26, the user (P01) is present in the living room, and the electronic device 400 (A01) during this time period is off. The off state of the electronic devices 400 (A01) may be automatically set by the device control unit 226 (which will be described later) of may be set by the user (P01) himself/herself through a scene command or an instruction from the user terminal 300.

During the same time period, the electronic device 400 (A02) is controlled in accordance with the operating condition (R01). The operating condition (R01) of the electronic device 400 (A02) may also be automatically set by the device control unit 226 or may be set by the user (P01). When the user (P01) has set an operating condition of the electronic device 400 (A02) that does not match any of registered operating conditions, the device control unit 226 assigns a new operation ID to the set operating condition.

The life information managing unit 230 records the life information 250 as appropriate by detecting a position where each user is present, the time period, and the operating conditions of the electronic devices 400 during the time period. The receiving unit 212 of the integrated terminal 100 periodically receives current operating conditions from the electronic devices 400.

FIG. 11 is a data structure table of basic setting information 260.

The basic setting information 260 is provided for each user, and defines operating conditions of the electronic devices 400 that are appropriate for the user depending on the time period and the place. The device control unit 226 generates the basic setting information 260 on the basis of the life information 250. For example, assume that, when the user (P01) is in the living room during a time period of “6:30 to 7:00”, the probability that the TV is on is 70% and the probability that the TV if off is 30%. In this case, the device control unit 226 sets the corresponding operating condition in the basic setting information 260 to turn on the TV (electronic device 400). In addition, when the TV is turned on, if the probability that a TV station B channel is viewed on the TV is higher than the probability that other TV station channels are viewed, the device control unit 226 sets the corresponding operating condition in the basic setting information 260 to set the channel to the TV station B.

The device control unit 226 also defines “operating conditions that are most likely to be selected” of the electronic devices 400, such as opening/closing of curtains, the set temperature of an air conditioner, and the like, in the basic setting information 260 on the basis of the life information 250 for each user, time period, and place. In other words, the basic setting information 260 defines the operating conditions of the electronic devices 400 that are the most suitable for the user's lifestyle. Hereinafter, a set of the operating conditions of the electronic devices 400 defined in the basic setting information 260 will be referred to as a “comfortable environment”.

When the user (P01) has entered the living room during a time period of “6:30 to 7:00”, the device control unit 226 automatically controls each of the electronic devices 400 (A01), (A02), (A03), and (A04) in accordance with the basic setting information 260 (the definition of the comfortable environment). Thus, when the user (P01) enters the living room, a comfortable environment suitable for the usual lifestyle of the user (P01) is provided without the need for such instructions as turning on the TV, opening the curtains, and turning on the air conditioner.

At this point, when the user has uttered a scene command such as “good morning”, the device control unit 226 controls the electronic devices 400 in accordance with the utterance setting information 240. The details of control (operating conditions) on the electronic devices 400 are recorded in the life information 250 by the life information managing unit 230. The device control unit 226 updates the basic setting information 260 on the basis of the life information 250. Thus, the integrated terminal 100 can provide a comfortable environment to the user in accordance with the basic setting information 260 and also flexibly change the basic setting information 260 in response to instructions from the user.

The device control unit 226 may define the basic setting information 260 on the basis of conditions other than the time period and the place. For example, whether or not the user (P01) is sitting at a desk, whether or not the user (P01) is sleeping, and the like may be detected by image recognition, and the device control unit 226 may change the operating conditions of the electronic devices 400 depending on the user's state.

Assume that, when sitting at the desk in the study, the user (P01) often turns on audio equipment to play music C as background music (BGM). The life information managing unit 230 records such a lifestyle in the life information 250. The device control unit 226 registers the “music C” as an operating condition of the audio equipment in the basic setting information 260 on the basis of the life information 250. In this case, when it is detected that the user is sitting at the desk in the study, the device control unit 226 may automatically power on the audio equipment in the study and play the music C or music of the same genre as the music C.

Because the basic setting information 260 is a file defining an environment in which the user feels comfortable, the device control unit 226 can automatically prepare a comfortable environment adjusted to the user's behaviors by referring to the basic setting information 260 without receiving particular instructions from the user.

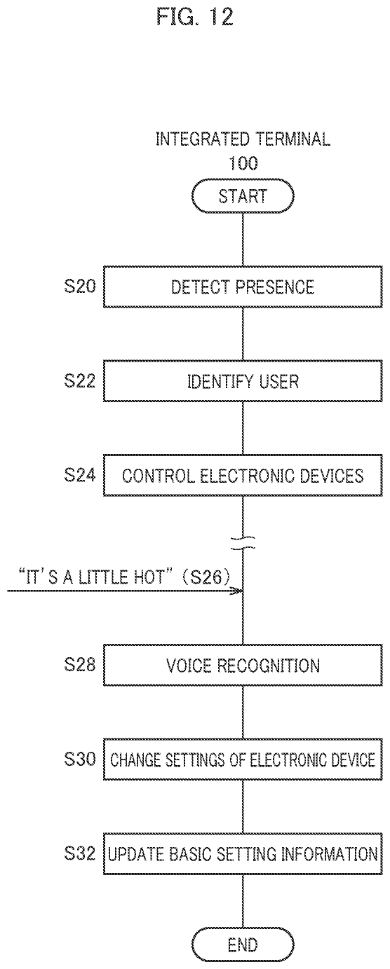

FIG. 12 is a flowchart illustrating processes performed when a user has got up and enters the living room.

When the user (P01) enters the living room, the presence detecting unit 222 detects the presence (entry) of the user (P01) by a motion detector installed in the living room (S20). The user identifying unit 218 identifies that the present user is the user (P01) by image recognition of a camera image or by receiving the user ID=P01 from the user terminal 300 (P01) (S22).

The device control unit 226 refers to the basic setting information 260 and controls the electronic devices 400 (S24). At the same time, the life information managing unit 230 records the life information 250 of the user (P01).

Assume that the user (P01) has uttered “it's a little hot” at this point (S26). The voice recognizing unit 220 identifies that the utterer is the user (P01) and recognizes such words as “a little” and “hot” (S28). The device control unit 226 associates “hot” with an operating condition of “lowering the temperature of the air conditioner” in advance. The device control unit 226 associates “a little” with “one degree” in advance. When the utterance “it's a little hot” of the user (P01) is detected, the device control unit 226 lowers the set temperature of the air conditioner by one degree (S30). The device control unit 226 changes the operating conditions of the electronic devices 400 as necessary in response to the user's utterance (uttered command).

For example, assume that the set temperature of the air conditioner is “25° C.” in the basic setting information 260 (settings of comfortable environment). In this case, the device control unit 226 changes the set temperature of the air conditioner from “25° C.” to “24° C.”. With the change in the set temperature, the life information managing unit 230 updates the life information 250. The device control unit 226 also changes the set temperature of the air conditioner in the basic setting information 260 to “24° C.” on the basis of the updated life information 250 (S32). According to such a control method, the integrated terminal 100 automatically sets the air conditioner to “25° C.” in accordance with the lifestyle of the user (P01), and when the user feels hot, the integrated terminal 100 lowers the set temperature of the air conditioner and changes the comfort temperature for the user (P01) (the set temperature of the air conditioner defined in the basic setting information 260) from “25° C.” to “24° C.”. Thus, when the user (P01) comes into the living room in the next morning, the device control unit 226 sets the air conditioner to “24° C.” in accordance with the updated basic setting information 260.

Note that, even when the life information 250 is updated, the basic setting information 260 is not necessarily updated right away. For example, in a case where the set temperature is instructed to be changed to “24° C.” only once while the comfort temperature is “25° C.”, the comfort temperature does not necessarily become “24° C.”. In contrast, in a case where the set temperature is instructed to be changed to “24° C.” many times while the comfort temperature is “25° C.”, the device control unit 226 may change the comfort temperature in the basic setting information 260 to “24° C.”. As described above, the device control unit 226 refers to a large amount of life information 250, and registers “a set temperature that is the most likely to be selected” as the comfort temperature in the basic setting information 260.

The life information managing unit 230 may update the life information 250 in accordance with an uttered command of the user (P01), and the device control unit 226 may update the basic setting information 260 with the update of the life information 250. Alternatively, the device control unit 226 may immediately update the basic setting information 260 on the basis of the uttered command of the user (P01). For example, when the user (P01) has uttered “it's a little hot” while the comfort temperature is “25° C.”, the device control unit 226 may immediately set the comfort temperature to “24° C.”.

When the utterance “it's a little hot” from the user is detected while the outdoor temperature is low, the device control unit 226 may lower the room temperature by opening a window instead of controlling the air conditioner. When the utterance “it's a little hot” from the user is detected while the outdoor temperature is higher than the room temperature by a predetermined value or larger, the device control unit 226 may lower the temperature of the air conditioner with the window kept closed. When an utterance “it's very hot” from the user is detected, the device control unit 226 may lower the set temperature of the air conditioner by two degrees. The method of controlling the electronic devices 400 in response to an uttered command from the user (P01) may be freely set.

In summary, when the user (P01) has entered the living room, the integrated terminal 100 automatically prepares a comfortable environment fir the user (P01) in accordance with the basic setting information 260. The integrated terminal 100 updates the basic setting information 260 as necessary on the basis of the uttered command from the user (P01) or an operation from the user terminal 300. The user can naturally change or adjust the “comfortable environment” through uttered commands or control of the electronic devices 400 using the user terminal 300.

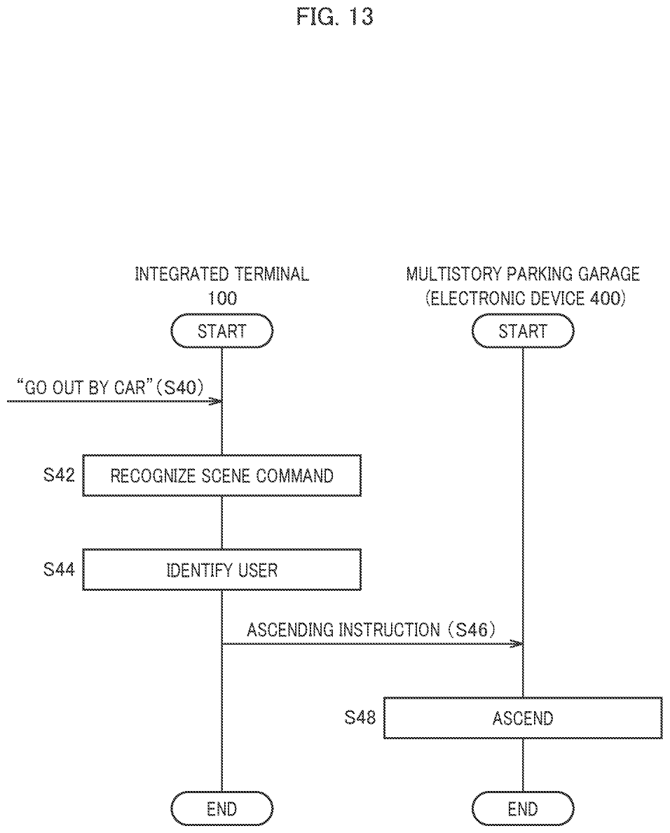

FIG. 13 is a flowchart illustrating processes performed when a user goes to work by car.

Assume that the user (P01) has given a scene command “go out by car” (S40). The voice recognizing unit 220 recognizes the scene command and identifies the command ID (S42). The voice recognizing unit 220 identifies that the utterer is the user (P01) (S44). The device control unit 226 refers to the utterance setting information 240 of the user (P01), and identifies the operating conditions of the electronic devices 400 associated with the scene command “go out by car”. Herein, ascending of a multistory parking garage (electronic device 400) is associated with the scene command “go out by car”.

The transmitting unit 210 of the integrated terminal 100 transmits an ascending instruction specifying the position where the car is stored to the multistory parking garage (electronic device 400) (S46). The transmitting unit 210 transmits the ascending instruction to the multistory parking garage over an LTE network. When a receiving unit of the multistory parking garage has received the ascending instruction, the multistory parking garage elevates a pallet, which is a frame on which a car is to be carried, so that the car can be taken out from the specified position (S48).

In this manner, when the user (P01) has only uttered “go out by car”, the integrated terminal 100 causes the multistory parking garage to start preparation for taking the car out. The user (P01) can readily take the car out upon arriving at the multistory parking garage without being kept waiting for the pallet to ascend near the multistory parking garage. In addition, if the outdoor temperature is a predetermined temperature or higher when the device control unit 226 of the integrated terminal 100 has recognized the scene command “go out by car”, the device control unit 226 may additionally instruct the car (electronic device 400) to start the engine and turn on the air conditioner.

When the user (P01) has taken the car out of the multistory parking garage, the device control unit 226 instructs the multistory parking garage to descend. Specifically, when the position detecting unit 214 has detected that the car is sufficiently away from the multistory parking garage, the device control unit 226 may transmit a descending instruction to the multistory parking garage.

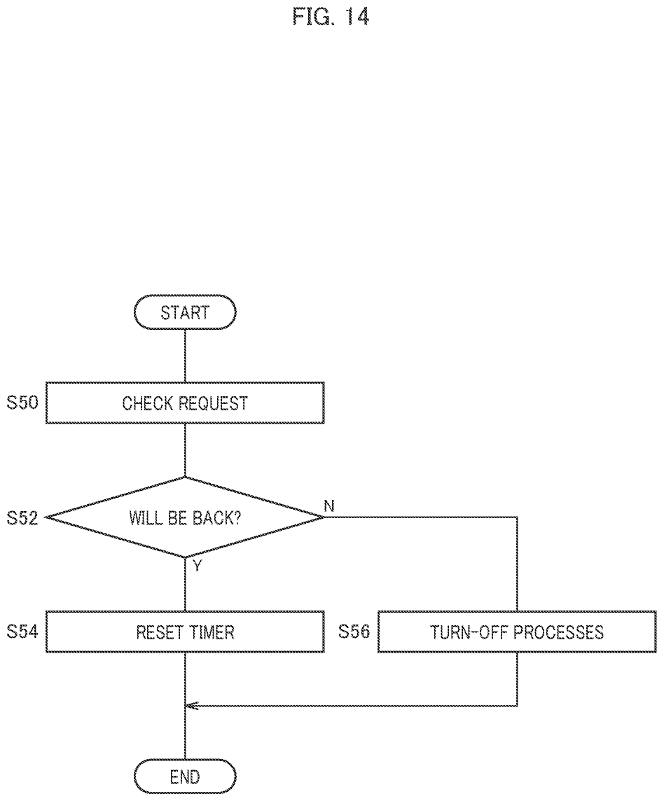

FIG. 14 is a flowchart illustrating processes performed when a user leaves a living room.

When the user (P01) has left the living room, the presence detecting unit 222 can detect the leaving of the user (P01). When no user is left in the living room, the device control unit 226 sets a timer. The timer is set for 20 minutes, for example. Herein, assume that user (P01) was the last to leave the living room. If the user (P01) does not return to the living room in 20 minutes, the processes illustrated in FIG. 14 are started.

The transmitting unit 210 transmits a confirmation request to the user (P01) (S50). The confirmation request used herein is an inquiry to check whether user (P01) will be right back or will not return anytime soon. If the user (P01) will be right back, the user (P01) operates the user terminal 300 to transmit a response indicating “be right back” to the integrated terminal 100. If the user (P01) will be right back (Y in S52), timer is reset for 10 minutes (S54). If no user returns to the living room within 10 minutes after the response of “be right back”, the processes in FIG. 14 are performed again.

If there is no response indicating “be right back” from the user (N in S52), the device control unit 226 turns off all the electronic devices 400 in the living room (S56). Specifically, if no user returns to the living room after the user(s) left the living room, the device control unit 226 turns off all the electronic devices 400, which can prevent waste of power.

The device control unit 226 may not only turn off electronic devices 400 but also shift electronic devices 400 into a power saving mode. The power saving mode used herein may be an operation mode in which power consumption can be reduced as compared with a normal operation. For example, the power saving mode may be a standby mode for a TV or a lower illumination mode in which the illumination is lower than a normal operation for lighting equipment. Hereinafter, the turning off of the electronic devices 400 and the shifting to the power saving mode will be collectively referred to as “turn-off processes” as illustrated in S56.

The device control unit 226 may check whether a user is present for each room, which is not limited to the living room. In addition, when no user is detected in a house, the device control unit 226 may perform the turn-off processes on all the electronic devices 400 in the house. In this process, the device control unit 226 may instruct doors and windows to lock.

The confirmation request in S50 is not essential. When a predetermined time has elapsed since all the users left the living room, the device control unit 226 may perform the turn-off processes without issuing a confirmation request.

The device control unit 226 may perform the turn-off processes in response to an uttered command from the user (P01). For example, when the user (P01) has uttered an uttered command “go out”, the device control unit 226 may perform the turn-off processes. In the turn-off processes, exception processing of keeping only the air conditioner on for a dog at home, for example, may be set in advance.

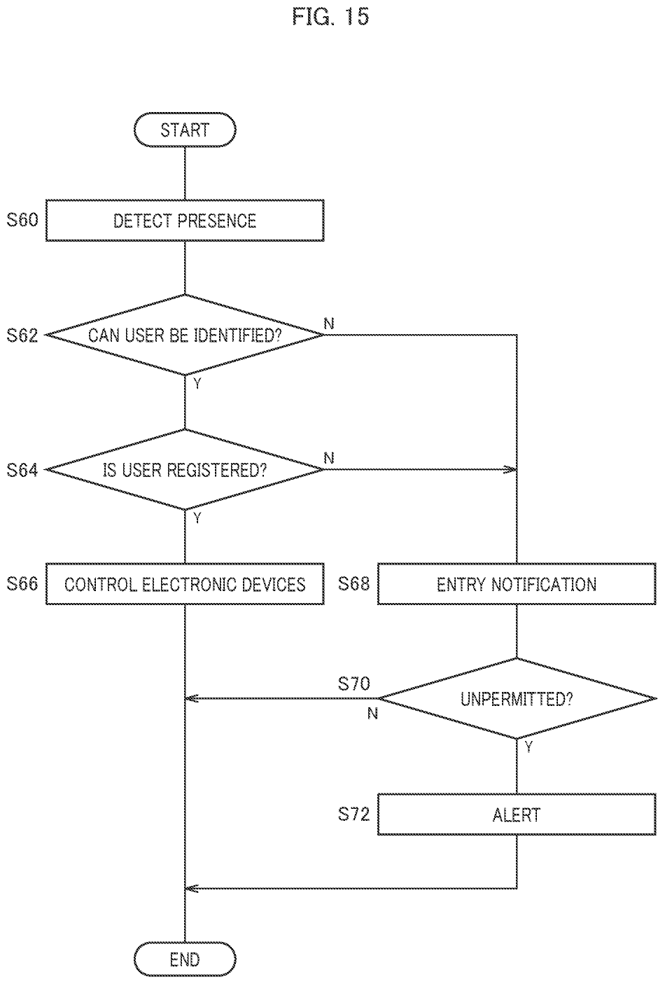

FIG. 15 is a flowchart illustrating processes performed when entry is detected at an entrance.

First, the presence detecting unit 222 detects a phenomenon of a person entering the entrance by a motion detector (S60). The user identifying unit 218 identifies the user ID of the present person (the user newly detected to have entered the entrance) (S62). Herein, assume that the user identifying unit 218 has identified the user ID of the present person by receiving the user ID from the user terminal 300 of the present person.

The user identifying unit 218 sets one or more users as “registered users” in advance. A registered user used herein refers to a member, such as a member of a family, who can freely enter and leave the home. If the user is identified (Y in S62) and the identified user is a registered user (Y in S64), the device control unit 226 controls the electronic devices 400 in accordance with the basic setting information 260 to prepare a comfortable environment for the user who has entered (S66).

If the person cannot be identified as a user (N in S62) or when the identified user ID is none of the user IDs of the registered users (N in S64), the person may be a suspicious person. Because, however, there is a possibility that a registered user has invited an unregistered user, such as a possibility that a member of the family has invited his/her friend into the home, the person cannot be determined to be a suspicious person at this point. When the person cannot be identified as a user or when a user ID of an unregistered user is detected, the transmitting unit 210 transmits an entry notification to registered users (S68). The entry notification includes a face photo of the person who has entered the entrance.

The registered users receive the entry notification from the integrated terminal 100 by the user terminals 300. When the person is not a suspicious person, such as when a registered user has taken his/her friend, who is an unregistered user, into the home, the registered user returns a permission notification. When the permission notification is transmitted, that is, when the entry is not an unpermitted entry (N in S70), subsequent processes are skipped and the entry of the unregistered user is permitted. In contrast, when no permission notification is transmitted, the entry is an unpermitted entry (Y in S70) and the alerting unit 216 therefore transmits an alert signal to an alarm device (S72). The alarm device outputs sound and informs a security company of the intrusion of a suspicious person.

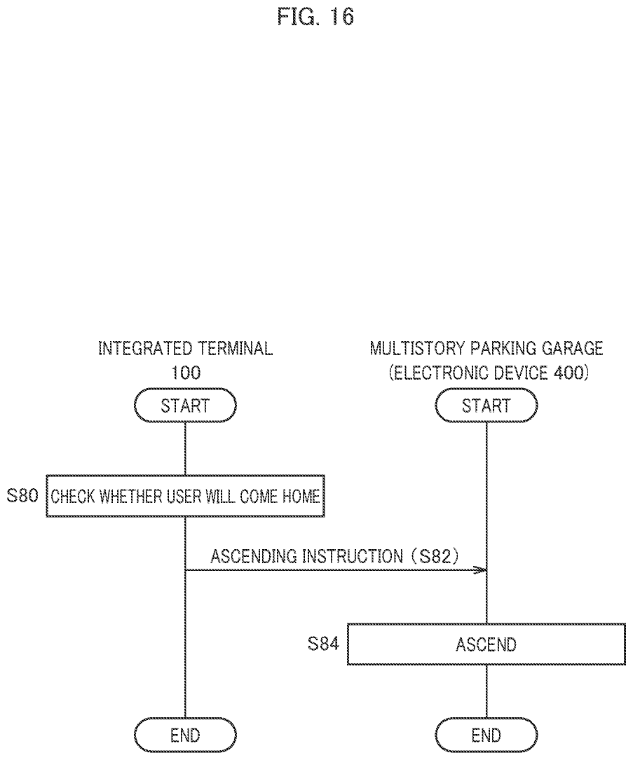

FIG. 16 is a flowchart illustrating processes performed when a user comes home by car.

The position detecting unit 214 detects that the car driven by the user (P01) is approaching the home. The device control unit 226 checks whether the user (P01) will come home when the car has come within a predetermined range from home (S80). When the car is sufficiently close to the multistory parking garage, the integrated terminal 100 may start preparation for putting the car into storage without waiting for confirmation from the user.

Assume that the user (P01) has operated the user terminal 300 to notify that the user (P01) will come home. When the user (P01) will come home, the integrated terminal 100 starts preparation for putting the car into storage. Specifically, the device control unit 226 transmits an ascending instruction to the multistory parking garage (electronic devices 400) (S82). Upon receiving the ascending instruction, the multistory parking garage elevates a pallet for preparation for putting the car into storage (S84).

According to such a control method, when the user (P01) is only approaching the home, the integrated terminal 100 starts preparation of the multistory parking garage for putting the car into storage, which eliminates the need for the user (P01) to wait for the pallet to ascend near the multistory parking garage. When the user (P01) has put the car in the multistory parking garage and moved sufficiently away from the multistory parking garage, the device control unit 226 instructs the multistory parking garage to descend. For example, the device control unit 226 may transmit a descending instruction to the multistory parking garage when the presence detecting unit 222 has detected that the user (P01) entered the home. The user terminal 300 may transmit position information of the user (P01) to the integrated terminal 100.

Note that there may be a case where preparation for taking or putting a car of another user (P02) out from or into storage is ongoing when the user (P01) is returning home. In this case, the multistory parking garage may notify the integrated terminal 100 and the user terminal 300 of status information indicating that the operation of taking/putting a car out/in is ongoing. When the operation of taking/putting a car out/in is completed, the multistory parking garage notifies the integrated terminal 100 and the user terminal 300 of status information indicating that it is available for a next operation. When the multistory parking garage is available for a next operation, the device control unit 226 may start an instruction to take/put a car out/in.

FIG. 17 is a data structure table of view setting information 270.

The view setting information 270 is provided for each user, and defines “positive conditions” and “negative conditions” on the basis of which the user selects a TV program. The positive conditions refer to conditions for TV programs that the user likes. The negative conditions refer to conditions for TV programs that the user dislikes.

For example, a “singer Q1” is set as a positive condition for the user (P01). The program schedule obtaining unit 228 obtains a TV schedule from a known web server through an Internet search in advance. On the basis of the positive conditions, TV programs meeting the positive conditions, such as TV programs in which the singer Q1 is scheduled to appear, become likely to be suggested from the TV schedule by the program suggesting unit 224 to the user (P01).

An “actor Q4” is set as a negative condition for the user (P01). On the basis of the negative conditions, TV programs in which the actor Q4 is scheduled to appear become less likely to be suggested by the program suggesting unit 224 to the user (P01). More specifically, the program suggesting unit 224 sets a recommendation value for each TV program. A TV program meeting more positive conditions has a higher recommendation value, and a TV program meeting more negative conditions has a lower recommendation value. The program suggesting unit 224 calculates the recommendation values of the TV programs on the basis of the view setting information 270 in advance.

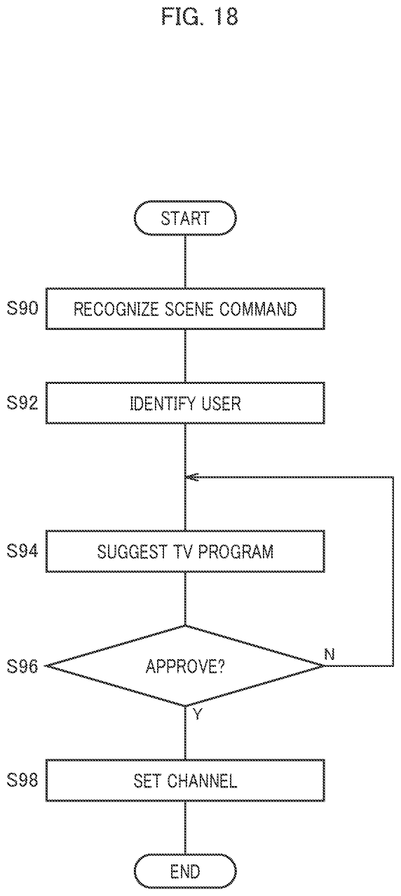

FIG. 18 is a flowchart illustrating processes performed when a user who has come home watches a TV program.

Herein, assume that the user who has come home by car has uttered a scene command “relax” in the living room. For the scene command “relax”, assume that an operating condition of “turning on the TV (electronic device 400)” is set.

The voice recognizing unit 220 performs voice recognition on the scene command (S90). The voice recognizing unit 220 identifies the user on the basis of the tone (S92). Herein, assume that the user ID=P01 is identified. The program suggesting unit 224 selects a TV program with the highest recommendation value from a plurality of TV programs being currently broadcasted and suggests the selected TV program to the user (P01) (S94). The program suggesting unit 224 may provide the suggestion by an audio output, or may transmit information on the recommended TV program to the user terminal 300 (P01).

When the user (P01) has approved the suggested TV program (Y in S96), the device control unit 226 turns on the TV and set the channel to that of the selected TV program (S98). The user (P01) informs the integrated terminal 100 of approval or denial by voice or by operating the user terminal 300.

If the user (P01) has denied the suggested TV program (N in S96), the program suggesting unit 224 suggests a TV program with a second highest recommendation value (S94). A TV program approved and selected by the user (P01) is recorded in the life information 250 by the life information managing unit 230. The device control unit 226 registers a TV program liked by the user (P01) in the basic setting information 260 on the basis of the life information 250.

For example, assume that the user (P01) has uttered a scene command “relax” at 18:15 in the living room. Assume that the program suggesting unit 224 has suggested a “professional baseball game” on the basis of the recommendation values of TV programs. Assume that the user (P01) has felt like watching a comedy program rather than professional baseball although he/she likes professional baseball. In this case, the user (P01) may deny the “professional baseball game” and wait until the program suggesting unit 224 suggests a comedy program, or may indicate to the integrated terminal 100 that “he/she feels like watching a comedy program”.

When a comedy program is selected, the life information managing unit 230 records the information that the user (P01) watches a “comedy program” at 18:15 in the life information 250. If the number of times the user (P01) watches a “comedy program” during the same time period increases, the device control unit 226 updates the basic setting information 260 to set, as a comfortable environment, turning on the TV and setting the channel to a “comedy program” when the user (P01) is in the living room at 18:15.

The user (P01) may set the view setting information 270 by himself/herself. The device control unit 226 may update the view setting information 270 on the basis of the cast or the genre of a TV program for which the user (P01) has selected the channel. For example, assume that the user (P01) has selected a TV program in which the actor Q4 (negative conditions) appears. In this case, because it can be deemed that the user (P01) does not dislike the actor Q4 so much as he/she used to, the device control unit 226 may exclude the actor Q4 from the negative conditions.

Assume that the user (P01) has frequently selected TV programs in which a singer Q6 appears. In this case, because it can be deemed that the user (P01) likes the singer Q6, the device control unit 226 may register the singer Q6 as a positive condition in the view setting information 270. Assume that the user (P01) has denied suggestion of a program in which the singer Q1 (positive condition) appears. In this case, because it can be deemed that the user (P01) does not like the singer Q1 so much as he/she used to, the device control unit 226 may exclude the singer Q1 from the positive conditions. In this manner, the device control unit 226 may update not only the basic setting information 260 but also the view setting information 270 as appropriate on the basis of the history of selections of TV programs made by the user (P01).

FIG. 19 is a functional block diagram of an electronic device 400.

FIG. 19 illustrates functional blocks relating to control performed by the integrated terminal 100 among the functional blocks of various electronic devices 400. The electronic device 400 includes a communication unit 402, a data processing unit 404, and a data storage unit 406. The communication unit 402 performs processing for communication with the integrated terminal 100 and the user terminals 300 over a wireless communication network or via near field radio communication. The data storage unit 406 stores various information data. The data processing unit 404 performs various processes on the basis of data obtained by the communication unit 402 and data stored in the data storage unit 406. The data processing unit 404 also functions as an interface of the communication unit 402 and the data storage unit 406.

The communication unit 402 includes a transmitting unit 410 for transmitting data and a receiving unit 408 for receiving data.

The data processing unit 404 includes an operation control unit 412 and a transfer determining unit 414.

The operation control unit 412 controls operations of the electronic device 400. For example, in a case where the electronic device 400 is an air conditioner, the operation control unit 412 sets the set temperature, the dehumidification, the air direction, the air volume, and the like of the air conditioner on the basis of control signals from the integrated terminal 100. The transfer determining unit 414 determines whether or not to transfer a control signal received from the integrated terminal 100 to another electronic device 400. Transfer of a control signal will be described in detail with reference to FIG. 20 as follows.

FIG. 20 is a sequence diagram illustrating a method for transferring a control command by a relay method.

The integrated terminal 100 may transmit a control command to a plurality of electronic devices 400 over an LTE network or may transmit a control command to electronic devices 400 via near field radio communication such as Bluetooth (registered trademark). In the case of near field radio communication, a control command transmitted from the integrated terminal 100 may not be received by electronic devices 400 located away from the integrated terminal 100. Thus, in the case of near field radio communication, a “relay method” is adopted so that a control command is reliably received by the corresponding electronic devices 400. For the “relay method”, “multi-hop communication functions” of a radio communication system may be used, for example.

First, assume that the user (P01) has uttered a scene command “let's cook” (S100). The device control unit 226 of the integrated terminal 100 refers to the basic setting information 260 and multicasts (broadcasts) a control command 1 (referred to as “command 1” in FIG. 20) via near field radio communication (S102). A control command includes a command ID for identifying the control command, device IDs and operating conditions of the electronic devices 400 to be controlled. In addition, multicasting used herein refers to transmitting a control command in a predetermined range without particularly specifying destinations. Herein, assume that only a microwave oven (electronic device 400) has received the control command 1.

Assume that the electronic device 400 to be controlled by the control command 1 is the air conditioner (electronic device 400) only. Because the microwave oven is not to be controlled by the control command 1, the microwave oven just multicasts the control command 1 without performing any operation control (S104). The integrated terminal 100 receives the control command 1 from the microwave oven but does not transfer (multicast) the received control command 1. A refrigerator (electronic device 400) also receives the control command 1 transmitted from the microwave oven.

Because the refrigerator is not to be controlled by the control command 1, the refrigerator multicasts the control command 1 without performing any operation control. The microwave oven receives the control command 1 transferred from the refrigerator. The transfer determining unit 414 of the microwave oven checks the command ID included in the control command 1, and does not further multicast the control command 1 if the control command is the previously received control command. Because the control command 1 is a control command that was received by the microwave oven and has been previously multicast by the microwave oven, the microwave oven does not further multicast the control command 1.

The air conditioner receives the control command 1 transmitted by the refrigerator. The control command 1 specifies the air conditioner by the device ID. Assume that an operating condition is set in the control command 1 to lower the set temperature of the air conditioner. The operation control unit 412 of the air conditioner lowers the set temperature in accordance with the control command 1 (S108). The control command 1 is a control command for changing the set temperature to be lower than usual before cooking is started because the room temperature is expected to rise during cooking. The air conditioner further transfers the control command 1. The refrigerator receives the control command 1, which the refrigerator previously received, and does not further transfer the control command 1.

Subsequently, assume that the user (P01) starts cooking by directly operating the microwave oven (S112). At this point, the transmitting unit 410 of the microwave oven transmits, together with a command ID, a control command 2 instructing to reduce power of the refrigerator and the air conditioner (S114). The integrated terminal 100 receives the control command 2 but does not transfer (multicast) the received control command 2. The refrigerator receives the control command 2 and thus lowers its power (S116). Because this is the first time to receive the control command 2, the transfer determining unit 414 of the refrigerator determines that the control command 2 needs to be multicast, and the transmitting unit 410 of the refrigerator multicasts the control command 2 (S118).

The microwave oven receives the control command 2, which the microwave oven previously received, and does not further transfer the control command 2. The air conditioner receives the control command 2, and thus lowers its power (S120). The transmitting unit 410 of the air conditioner multicasts the control command 2. The refrigerator, which previously received the control command 2, does not further transfer the control command 2. According to such a control method, when cooking with the microwave oven is started, power consumption of the refrigerator and the air conditioner can be autonomously reduced for an expected increase in power consumption of the microwave oven.

### [Summary]

The methods for controlling electronic devices in the integrated electronic device system 200 have been described above on the basis of the embodiments.

In the first embodiment, use of the integrated terminal 100 allows each user to control a plurality of electronic devices 400 together by the user terminal 300. The integrated terminal 100 can cause the electronic devices 400 to operate with most suitable settings for each user upon being turned on by referring to the use histories of the electronic devices 400 for the user. Furthermore, when a user indicates a change in a set value or a selection to the integrated terminal 100, the integrated terminal 100 can change the most suitable settings of the electronic devices 400. Thus, even in a case where the electronic devices 400 have various parameters, the integrated terminal 100 can appropriately control the electronic devices 400 on the basis of the use histories and the user's selections.

When a user merely turns on a new electronic device 400 with a remote control, the integrated terminal 100 can register the new electronic device 400 in the device list. Similarly, a turn-on interface for the new electronic device 400 is added to the user terminal 300. This reduces the troublesomeness in installing and setting an electronic device 400.

A user's lifestyle typically has a certain level of stability (pattern). The life information managing unit 230 of the integrated terminal 100 records the lifestyle of each user in the form of life information 250 on the basis of the user's behavior, and the device control unit 226 generates the basic setting information 260 on the basis of the life information 250. The basic setting information 260 defines a “comfortable environment” suitable for the user's lifestyle. For example, some people turn on the TV while at work but others do not. The integrated terminal 100 in the second embodiment can set a comfortable environment for a user suitable for the user's lifestyle in advance.

Furthermore, the user can freely intervene in setting a comfortable environment based on the basic setting information 260 by using the user terminal 300 or by voice utterance. The basic setting information 260 is updated as appropriate on the basis of the life information 250, which allows the user to obtain a comfortable environment by performing minimum operations or instructions.

The integrated terminal 100 in the second embodiment can receive instructions from users, but basically serves as a “butler” that gently realizes a comfortable environment for each user. It is not essential to connect the integrated terminal 100 to the Internet. As described with reference to FIG. 20, the integrated terminal 100 may be configured to communicate only with user terminals 300 and electronic devices 400 located nearby via near field radio communication such as Bluetooth (registered trademark). With such a configuration, the risk of leakage of privacy information (the basic setting information 260, etc.) of users held by the integrated terminal 100 via the Internet can be prevented.

When a user has left a space such as a living room, the integrated terminal 100 automatically performs the turn-off processes on the electronic devices 400. The turn-off processes performed by the integrated terminal 100 on the electronic devices 400 not only reduce waste of power but also contribute to safe operation of the electronic devices 400.

The integrated terminal 100 in the second embodiment instructs ascending and descending of a multistory parking garage in advance, which reduces the waiting time at the multistory parking garage.

The integrated terminal 100 can actively suggest TV programs according to each user's preference on the basis of the view setting information 270. A user can have a favorite TV program set by the integrated terminal 100 only by uttering a scene command such as “relax” or only by entering a living room.

As described above, a human behavioral tendency has a certain level of stability (pattern). What makes a human behavioral pattern is the person's experience. The life information managing unit 230 of the integrated terminal 100 records each user's experience in the life information 250. The device control unit 226 of the integrated terminal 100 generates the basic setting information 260 indicating comfortable environments for each user on the basis of the life information 250. The integrated terminal 100 controls the electronic devices 400 on the basis of the basic setting information 260. According to such a configuration, the integrated terminal 100 can always readily and appropriately suggest “a comfortable environment at the time” on the basis of each user's experience.

The present invention is not limited to the embodiments described above and modifications thereof, and any component thereof can be modified and embodied without departing from the scope of the invention. Components described in the embodiments and modifications can be combined as appropriate to form various other embodiments. Some components may be omitted from the components presented in the embodiments and modifications.

### Modifications

In the description of the first embodiment, the integrated terminal 100 manages the use histories of the individual electronic devices 400. In a modification, each electronic device 400 may manage its use history. In this case, each electronic device 400 may include a use history managing unit for managing its use history for each user, a turn-on receiving unit for receiving a turn-on signal from a user terminal 300 or a remote control, a turn-on control unit for turning itself on upon receiving the turn-on signal, and a setting unit for initially setting its operating conditions.

For example, assume that a new air conditioner has been purchased. In this case a communication unit of the air conditioner may transmit specifying information of the air conditioner to the integrated terminal 100, and the integrated terminal 100 may register the air conditioner in the device list on the basis of the specifying information. In addition, the integrated terminal 100 may generate an operation screen 310 including a turn-on interface for the air conditioner and provide the operation screen 310 to the user terminal 300.

Assume that it is not an electronic device 400 but an integrated terminal 100 that is newly installed. In this case, the electronic devices 400 may each inform the integrated terminal 100 of use history information. According to such a control method, even when the integrated terminal 100 gets out of order, the individual electronic devices 400 have back-ups of the use history information, which allows the service of the integrated terminal 100 to be readily continued.

When each electronic device 400 manages its use history, a second turn-on signal is first transmitted from a user terminal 300 to the integrated terminal 100, and a first turn-on signal is transmitted from the integrated terminal 100 to the electronic devices 400. The setting unit of each electronic device 400 refers to the use history and sets its operating conditions. The setting result may be conveyed to the user terminals 300 via the integrated terminal 100. Each electronic device 400 may transmit a URL (Uniform Resource Locator) of a web page for controlling itself to the user terminals 300. A user can change a set value of an electronic device 400 by accessing a specified URL by using the user terminal 300. The use history managing unit of the electronic device 400 updates the use history information as a result of the change in settings.

Each user terminal 300 may store various personal information on the user. Each user terminal 300 provides all or part of the personal information to the integrated terminal 100, and the integrated terminal 100 may change the settings of each electronic devices 400 on the basis of not only the use history but also the personal information. For example, in a case where a user P1 likes traveling, the integrated terminal 100 may select the channel of a travel program when turning on the TV. In a case where a user P2 has recently played shogi (Japanese chess), the integrated terminal 100 may select the channel of a shogi program when turning on the TV. In a case where a user P3 has an allergy to pollens, when a pollen alert is issued, the integrated terminal 100 may turn on an air cleaner when the user returns home. Deep analysis of users' personal information in this manner allows the integrated terminal 100 to control a plurality of electronic devices 400 in a more sophisticated manner.

In a case where each electronic device 400 manages its use history, assume that a user has given an instruction of “relax”. In this case, the integrated terminal 100 turns on an “air conditioner” and a “TV”. The air conditioner determines set values on the basis of the use history. Similarly, the TV determines its settings (the channel, for example) on the basis of the use history.

In the description of the first embodiment, the integrated terminal 100 generates an operation screen 310, and a user terminal 300 displays the operation screen 310 on a web browser. In a modification, each user terminal 300 may include an operation screen generating unit. For example, when an “air conditioner” is registered, the operation screen generating unit of the user terminal 300 may generate an operation screen 310 including an “air conditioner” button. When the user has touched the “air conditioner” button, a second turn-on signal including an ID associated with the air conditioner may be transmitted from the user terminal 300 to the integrated terminal 100.

In the description, the operating conditions of the electronic devices 400 depending on the place and time are set in addition to scene commands in the utterance setting information 240. In the life information 250 as well, the operation states of the electronic devices 400 depending on the place and time are recorded. The same applies to the basic setting information 260.

The operating conditions of the electronic devices 400 may also be set depending on each user's situation apart from the place and time. For example, the device control unit 226 may image a user with a camera, perform image recognition to recognize the behavior of the user such as “working (operating a PC at a table)”, “cooking”, or “relaxing (sitting on a sofa)”, and set the operating conditions of the electronic devices 400 depending on the behavior of the user. The device control unit 226 may turn off the TV while the user (P01) is working in the living room in the morning, and turn on the TV while the user (P01) is relaxing in the living room in the morning.

Apart from users' behaviors, the integrated terminal 100 may control the electronic devices 400 on the basis of the body condition or the feeling. The method of controlling the electronic devices 400 may be changed on the basis of a respiratory sound, a heat value, a cough, a face expression, a voice volume or tone, and the like of each user.

The life information managing unit 230 records the life information 250 in terms of various items such as place, time, behavior, and body condition. The device control unit 226 generates the basic setting information 260 on the basis of the life information 250. Such a control method allows more suitable comfortable environment to be provided depending on each user's condition.

Priority levels may be set to users in advance. For example, assume that a user (P01) and a user (P02) are in the living room at the same time. The user (P01) has a higher priority level than the user (P02). In this case, the device control unit 226 of the integrated terminal 100 may control the electronic devices 400 on the basis of the basic setting information 260 of the user (P01). Alternatively, the device control unit 226 may set a median of the comfortable environments of the user (P01) and the user (P02) as a comfortable environment for the two. For example, in a case where the user (P01) prefers “25° C.” and the user (P02) prefers “23° C.” for the set temperature of the air conditioner, the device control unit 226 may set the average “24° C.” for the set temperature of the air conditioner.

The integrated terminal 100 may be a box-shaped device installed indoors, or may be a device portable by individuals like the user terminals 300. The integrated terminal 100 may be a wearable terminal such as an earring, an accessory, a watch or the like.

In the description of the embodiments, particularly the second embodiment, voice commands such as the scene commands that are defined in advance are assumed as uttered commands. Uttered commands are not limited thereto, and the voice recognizing unit 220 may extract words from free utterances such as “I feel hot”, “isn't it hot?”, “I need ventilation”, and the like by voice recognition, and the device control unit 226 may control the electronic devices 400 in accordance with the electronic devices 400 and the operating conditions associated in advance with the extracted words.

Commands are not limited to scene commands, and the users may give direct voice instructions on operations of the electronic devices 400. For example, the device control unit 226 may turn on the air conditioner (electronic device 400) when a user has uttered “turn on the air conditioner”. In this case as well, the life information managing unit 230 updates the life information 250, and the device control unit 226 updates the basic setting information 260 as necessary with the update of the life information 250.

The device control unit 226 may control the electronic devices 400 on the basis of cancellation utterances. For example, assume that the user (P01) has uttered “don't turn on the TV” when the device control unit 226 turned on the TV in accordance with the basic setting information 260. In this case, the voice recognizing unit 220 recognizes “don't turn on (turn off)” and “TV” by voice recognition, and the device control unit 226 turns off the TV on the basis of the recognition result. In this case, the life information managing unit 230 records turning off of the TV in the life information 250.

When a cancellation utterance is given with respect to a scene command, the device control unit 226 may update the utterance setting information 240. For example, assume that the utterance setting information 240 is set to fully open electric windows (electronic device 400) when a user (P03) utters a scene command “good morning”. Also assume that the user (P03) has given a cancellation utterance “don't open the windows” within a predetermined time, such as within 20 seconds, since the user (P03) uttered a scene command “good morning”. In this case, the device control unit 226 stops the window opening operation. If the windows are already open, the device control unit 226 instructs the windows to close. The device control unit 226 also updates the utterance setting information 240 to delete the “operation of fully opening the windows” associated with the scene command “good morning” of the user (P03). According to such a control method, the user (P03) can freely change the operations associated with the scene command “good morning” by using voice.

In another example, assume that no operating condition relating to the electric windows is set in association with the scene command “good morning” of a user (P04). Assume that the user (P04) has given an additional voice instruction “open the windows, too” within a predetermined time since the user (P04) uttered the scene command “good morning”. In this case, the device control unit 226 instructs the windows (electronic device 400) to perform an opening operation in addition to controlling the electronic devices 400. The device control unit 226 may update the utterance setting information 240 to add the “operation of opening the windows” in association with the scene command “good morning” of the user (P04).

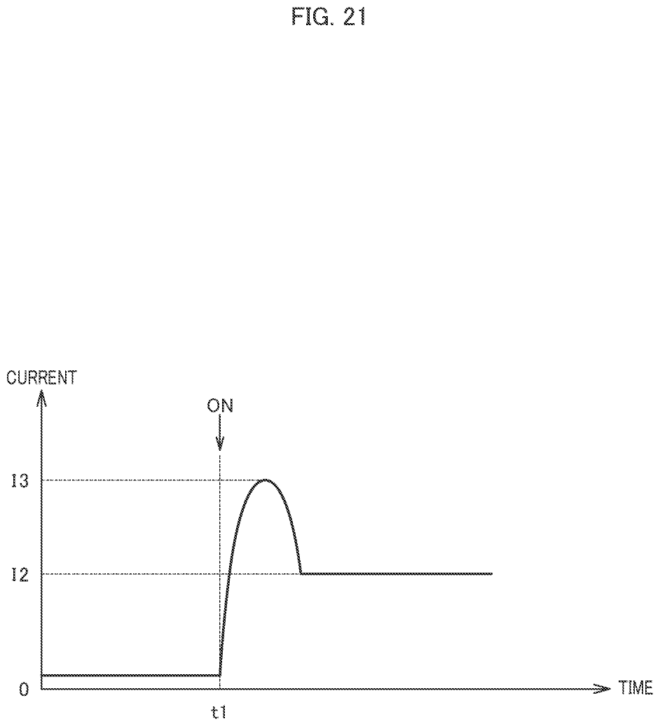

FIG. 21 is a schematic diagram for explaining inrush current.

The horizontal axis represents time, and the vertical axis represents a current value flowing through a power line to which an electronic device 400 is connected. FIG. 21 shows a change in current when an instruction to turn on an electronic device 400 (A10) at time t1 is performed. In a normal mode, that is, during normal operation of the electronic device 400 (A10), the current value (hereinafter referred to as a “normal current value”) is I2. Immediately after the electronic device 400 (A10) is turned on, however, a current larger than the normal current value I2 may temporarily flow. This is called inrush current.

Immediately after the electronic device 400 (A10) is turned on, the current value is temporarily I3 (>I2). There are various causes of the inrush current. For example, immediately after the electronic device 400 (A10) is turned on, a capacitor of a smoothing circuit in the electronic device 400 (A10) needs charging, during which a large current is likely to flow temporarily. When inrush current flows, the operations of other electronic devices 400 connected to the same power line as the electronic device 400 (A10) may become instable. Suppression of inrush current is therefore an important challenge in control of a large number of electronic devices 400. In particular, an electronic device 400 with a higher normal current value is likely to have a larger inrush current peak.

The electronic device 400 (A10) described below has a standby mode, a normal mode, and an intermediate mode (power saving mode) in which the electronic device 400 (A10) operates with a current value lower than the normal current value. In the standby mode, the electronic device 400 (A10) can receive instructions from the integrated terminal 100 but is not operating. The current value in the standby mode (hereinafter referred to as a “standby current value”) is very small.

In the intermediate mode, some functions of the electronic device 400 (A10) are limited as compared with the normal mode, so that the electronic device 400 (A10) operates in a power saving manner. For example, in a case where the electronic device 400 (A10) is an air conditioner, the air conditioner may be set so that air blowing operation can be performed but cooling operation cannot be performed in the intermediate mode. Alternatively, the air conditioner may be set so that cooling operation can be performed but the temperature can only be set to 22° C. or higher in the intermediate mode.

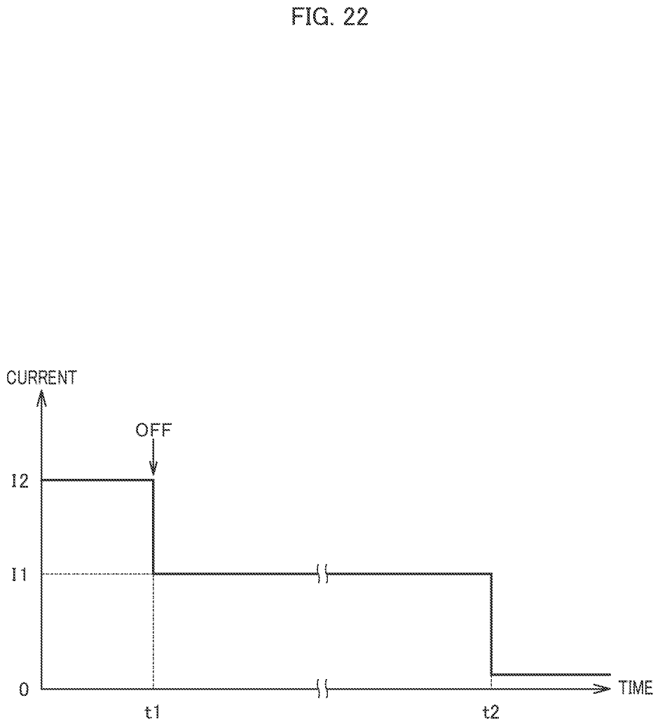

FIG. 22 is a schematic diagram showing a change in current when an electronic device 400 is turned off.

Assume that a user instructed the electronic device 400 (A10) operating in the normal mode to turn off at time t1. As described above, the normal current value is I2. At this point, the integrated terminal 100 does not change the operation mode of the electronic device 400 (A10) from the normal mode to the standby mode but changes it from the normal mode to the intermediate mode. The current value (hereinafter referred to as an “intermediate current value”) flowing in the electronic device 400 (A10) in the intermediate mode is I1. The intermediate current value I1 is larger than the standby current value but smaller than the normal current value I2. Hereinafter, an instruction from the integrated terminal 100 to an electronic device 400 to change from the normal mode to the intermediate mode will be referred to as an “intermediate off instruction”.

When a user has transmitted an instruction to turn off the electronic device 400 (A10) to integrated terminal 100, the turn-on transmitting unit 112 of the integrated terminal 100 transmits an intermediate off instruction to the electronic device 400 (A10). When the intermediate off instruction is received from the integrated terminal 100, the operation mode of the electronic device 400 (A10) is changed from the normal mode to the intermediate mode.

When a user has transmitted an instruction to turn on the electronic device 400 (A10) in the intermediate mode, the integrated terminal 100 turns on the electronic device 400 (A10). In this case, the electronic device 400 (A10) is changed from the intermediate mode to the normal mode. Because a change in current caused by the change from the intermediate mode to the normal mode is smaller than the current change caused by the change from the standby mode to the normal mode, the inrush current can also be suppressed.

When the integrated terminal 100 has not received a turn-on instruction for a predetermined time since the integrated terminal 100 transmitted the intermediate off instruction, the turn-on transmitting unit 112 of the integrated terminal 100 transmits a turn-off instruction to the electronic device 400 (A10) at time t2. As a result, the operation mode of the electronic device 400 (A10) changes from the intermediate mode to the standby mode.

Even when the electronic device 400 (A10) is turned off (standby mode), the user may return the electronic device 400 (A10) to the on state (normal mode) right away. Thus, setting to the intermediate mode between the normal mode and the standby mode when a turn-off instruction is given suppresses inrush current that occurs when a turn-on instruction is given again. In addition, when some time has elapsed since the operation mode is changed to the intermediate mode, the integrated terminal 100 automatically sets the electronic device 400 (A10) to the standby mode to suppress power consumption of the electronic device 400 (A10).

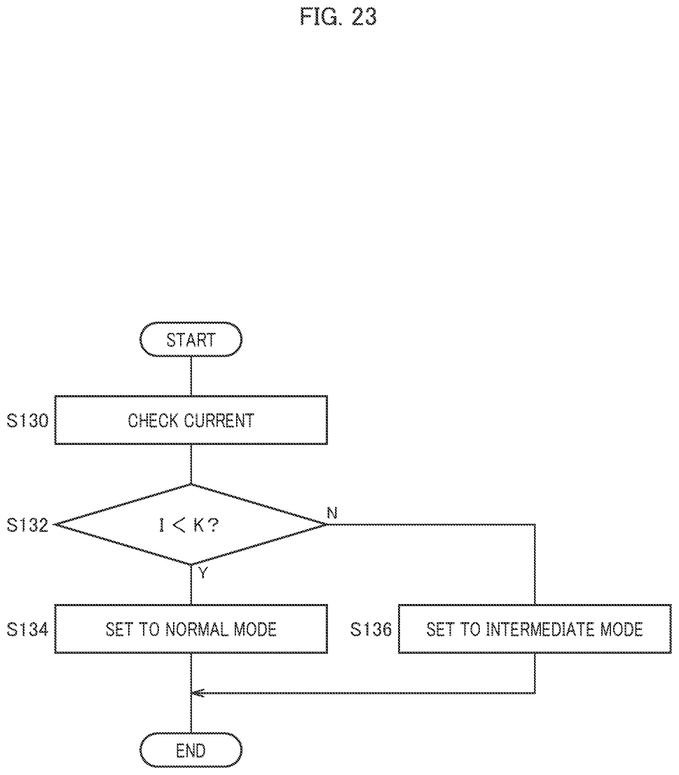

FIG. 23 is a flowchart illustrating processes performed by the integrated terminal 100 for turning on an electronic device 400.

Herein, assume that a plurality of electronic devices 400 and the electronic device 400 (A10) are connected to a single power line. When a user has transmitted an instruction to turn on the electronic device 400 (A10) to the integrated terminal 100, the integrated terminal 100 performs the processes illustrated in FIG. 23. Also assume that the electronic device 400 (A10) is in the standby mode.

When a turn-on instruction is received, a current checking unit (not illustrated) of the integrated terminal 100 checks the current value of the power line to which the electronic device 400 (A10) is connected (S130). The current checking unit may obtain the current value from an ammeter (not illustrated) connected to the power line, for example.

An allowable value L is set for the current value flowing through the power line. When the current value I is smaller than a threshold K (<L) (Y in S132), the turn-on transmitting unit 112 of the integrated terminal 100 transmits a turn-on instruction to the electronic device 400 (A10) and sets the electronic device 400 (A10) to the normal mode (S134) This is because inrush current, if any, does not have any negative effect on other electronic devices 400 when the current value flowing through the power line is sufficiently small.

In contrast, when the current value I at this point is equal to or larger than the threshold K (N in S132), the turn-on transmitting unit 112 sets the electronic device 400 (A10) to the intermediate mode (S136). When the current value flowing through the power line is large, changing the operation mode of the electronic device 400 (A10) from standby mode to the intermediate mode suppresses the inrush current. When a predetermined time has elapsed since the operation mode was changed to the intermediate mode, the integrated terminal 100 changes the electronic device 400 to the normal mode. Alternatively, when a predetermined time has elapsed since the operation mode was changed to the intermediate mode, the electronic device 400 may automatically change to the normal mode.

Note that, when an instruction to turn on the electronic device 400 (A10) in the intermediate mode is received, the integrated terminal 100 may change the electronic device 400 (A10) from the intermediate mode to the normal mode without checking the current (S130). The device control unit 226 of the integrated terminal 100 may inquire of the electronic device 400 (A10) to check the current operation mode of the electronic device 400 (A10).

In the description above, when a user has transmitted a turn-off instruction to the integrated terminal 100, the integrated terminal 100 temporarily sets the electronic device 400 (A10) to the intermediate mode and thereafter to the standby mode. Alternatively, a user may freely use a turn-off instruction and an intermediate off instruction depending on the circumstances. When a user has instructed to turn off the electronic device 400 (A10), the integrated terminal 100 changes the electronic device 400 (A10) to the standby mode. When the user has given an intermediate off instruction for the electronic device 400 (A10), the integrated terminal 100 may change the electronic device 400 (A10) to the intermediate mode.

The turn-on transmitting unit 112 of the integrated terminal 100 may set the mode of the electronic device 400 (A10) on the basis of a user's lifestyle indicated in the life information 250. Assume that the user (P01) has instructed to turn off the electronic device 400 (A10). The turn-on transmitting unit 112 refers to the life information 250 and, if the user (P01) is likely to go out during the time period (for example, an 80% or higher likelihood of being out), sets the electronic device 400 (A10) to the standby mode. If the user (P01) is unlikely to go out during the time period, the turn-on transmitting unit 112 may set the electronic device 400 (A10) to the intermediate mode for an expected instruction to turn on again.

Upon receiving a turn-off instruction from the user (P01), the integrated terminal 100 may set the electronic device 400 (A10) to the intermediate mode, refer to the life information 250, and then set electronic device 400 (A10) to the standby mode when a time period during which the user (P01) is likely to go out has come.

When turning off the electronic device 400 (A10), the integrated terminal 100 may always set the electronic device 400 (A10) to the intermediate mode before setting to the standby mode.

A plurality of intermediate modes may be set between the standby mode and the normal mode. A first intermediate mode to an n-th intermediate mode associated with a first intermediate current value, a second intermediate current value, . . . , and an n-th intermediate current value, respectively, between the normal current value and the standby current value may be set. When turning off an electronic device 400, the integrated terminal 100 may change the electronic device 400 from the normal mode to the first intermediate mode, then from the intermediate mode to the intermediate mode after the elapse of a predetermined time, and so on, so that there are a plurality of steps before the electronic device 400 is finally set to the standby mode. Similarly, when turning on an electronic device 400, the integrated terminal 100 may change the electronic devices 400 from the standby mode to an n-th intermediate mode, so that there are a plurality of steps before the electronic device 400 is finally set to the normal mode.

As described above, setting to the intermediate mode(s) effectively suppresses occurrence of a large inrush current caused by a change from the standby current value to the normal current value.

1. An electronic device controller comprising:
a basic setting storage unit storing basic setting information associating a user ID and a time period with operating conditions of one or more electronic devices;
a user identifying unit to obtain a user ID by identifying a user; and
a device control unit to control one or more electronic devices on the basis of the identified user and a current time by referring to the basic setting information, wherein
when the user has instructed to change an operating condition of an electronic device, the device control unit changes the operating condition of the electronic device and updates the basic setting information.

2. The electronic device controller according to claim 1, further comprising:
a voice recognizing unit to recognize an uttered command uttered by the user, wherein
the device control unit changes the operating condition of the electronic device on the basis of the uttered command from the user and updates the basic setting information on the basis of the uttered command.

3. The electronic device controller according to claim 1, wherein
the basic setting storage unit stores a set temperature of air conditioning equipment in the basic setting information, and
the device control unit controls a set temperature of the air conditioning equipment by referring to the basic setting information, and when the user has instructed to change the set temperature of the air conditioning equipment, the device control unit changes the set temperature of the air conditioning equipment and also changes the set temperature of the air conditioning equipment in the basic setting information.

4. The electronic device controller according to claim 1, further comprising:
a presence detecting unit to detect presence of a user in a space of a predetermined range, wherein
the user identifying unit identifies a user ID of the user detected to be present in the space, and
the device control unit controls one or more electronic devices on the basis of the basic setting information of the identified user.

5. The electronic device controller according to claim 4, wherein
when the presence of the user once detected to be present in the space by the presence detecting unit is no longer detected, the device control unit causes one or more electronic devices associated with the space to enter a stop or power-saving mode.

6. The electronic device controller according to claim 1, further comprising:
a position detecting unit to detect position information of a car, wherein
when the car is within a predetermined range, the device control unit instructs a multistory parking garage to prepare for putting the car into storage.

7. The electronic device controller according to claim 6, further comprising:
a voice recognizing unit to recognize an uttered command uttered by a user, wherein
when an uttered command indicating that a user will go out by car, the device control unit instructs the multistory parking garage to prepare for taking the car out.

8. The electronic device controller according to claim 1, further comprising:
a voice recognizing unit to recognize an uttered command uttered by a user; and
an utterance setting storage unit storing utterance setting information associating a user ID and an uttered command with operating conditions of one or more electronic devices, wherein
the device control unit further controls one or more electronic devices on the basis of the identified user and the uttered command by referring to the utterance setting information, and when the user has instructed to change an operating condition of an electronic device, the device control unit changes the operating condition of the electronic device and updates the utterance setting information.

9. The electronic device controller according to claim 1, further comprising:
a program schedule obtaining unit to obtain a TV schedule from an external device;
a view setting storage unit storing view setting information associating a user with a viewing condition; and
a program suggesting unit to suggest a TV program meeting the viewing condition of the identified user on the basis of the identified user and the current time by referring to the TV schedule and the view setting information.

10. The electronic device controller according to claim 1, further comprising:
a presence detecting unit to detect presence of a user in a space of a predetermined range; and
an alerting unit to transmit an alert signal, wherein
the user identifying unit identifies a user ID of the user detected to be present in the space,
when the identified user ID is any of one or more user IDs registered in advance, the device control unit causes one or more electronic devices to start operating on the basis of the identified user and the current time by referring to the basic setting information, and
when the identified user ID is none of one or more user IDs registered in advance or when no user ID is identified, the alerting unit transmits an alert signal.

11. An electronic device comprising:
a receiving unit to receive a control signal including a command ID, a device ID, and an operation command via near field radio communication from an external electronic device controller;
an operation control unit to perform operation settings of the electronic device in accordance with the operation command included in the control signal when the received device ID is a device ID of the electronic device; and
a transmitting unit to transmit the control signal via near field radio communication, wherein
the transmitting unit refers to the command ID in the received control signal and, when the control signal has not been previously received, transmits the control signal.

12. An electronic device controller comprising:
a use history managing unit to manage use history of an electronic device for each user;
a turn-on receiving unit to receive a turn-on signal to turn on the electronic device together with a user ID from a user terminal;
a turn-on transmitting unit to transmit a turn-on signal to the electronic device upon receiving the turn-on signal; and
a setting transmitting unit to transmit a setting signal based on the use history associated with the user ID to the electronic device.

13. The electronic device controller according to claim 12, wherein
the turn-on receiving unit receives a multi-turn-on signal being a single turn-on signal for a plurality of electronic devices together with a user ID from a user terminal,
upon receiving the multi-turn-on signal, the turn-on transmitting unit transmits a turn-on signal to each of the plurality of electronic devices specified in the multi-turn-on signal,
the setting transmitting unit transmits setting signals each based on the user ID and use history of each of the plurality of electronic devices specified in the multi-turn-on signal to each of the plurality of electronic devices together.

14. The electronic device controller according to claim 12, wherein
upon receiving the setting signal for the electronic device together with the user ID from the user terminal, the use history managing unit updates user history information associated with the user ID and the electronic device.

15. The electronic device controller according to claim 12, further comprising:
a signal pattern storage unit storing an electronic device and a pattern of control signals for the electronic device in association with each other;
a signal detecting unit to detect control signals for an electronic device;
an acknowledgement signal transmitting unit to transmit an acknowledgement signal to a user terminal when the detected control signals correspond to an unregistered pattern;
a specifying information receiving unit to receive specifying information of an electronic device together with the user ID from the user terminal; and
an electronic device registering unit to newly register the electronic device in a control list upon receiving the specifying information.

16. The electronic device controller according to claim 15, further comprising:
an operation providing unit to transmit an operation screen for turning on the newly registered electronic device to the user terminal.

17. The electronic device controller according to claim 12, further comprising:
a name receiving unit to receive an operation name; and
a name registering unit to register the operation name in association with a plurality of electronic devices when turn-on signals for the plurality of electronic devices are successively received and the operation name is subsequently received, wherein
when a turn-on signal including the operation name is received, the turn-on transmitting unit transmits the turn-on signal to each of the plurality of electronic devices associated with the operation name.

18. A communication terminal comprising:
an operation screen display unit to display an operation screen including turn-on buttons respectively associated with a plurality of electronic devices;
an acknowledgement signal receiving unit to receive an acknowledgement signal from the electronic device controller according to claim 12;
a specifying information transmitting unit to transmit specifying information of an electronic device to the electronic device controller after the acknowledgement signal is received;
an operation screen generating unit to add a turn-on button for the electronic device on the operation screen after the specifying information is transmitted; and
a turn-on signal transmitting unit to transmit a turn-on signal for an electronic device associated with a selected turn-on button to the electronic device controller when one of the turn-on buttons displayed on the operation screen is selected.

19. An electronic device comprising:
a use history managing unit to manage use history of the electronic device for each user;
a turn-on receiving unit to receive a turn-on signal together with a user ID from a user terminal;
a turn-on control unit to turn on the electronic device upon receiving the turn-on signal; and
a setting unit to initially set an operating condition of the electronic device on the basis of the user history associated with the user ID.
